(19) United States
(12) Patent Application Publication
(10) Pub. No.: US 2026/0231147 A1
(43) Pub. Date: Aug. 6, 2026

(54) PHYSICAL LAYER PROCEDURES FOR CARRIER AGGREGATION SWITCHING

(71) Applicant: QUALCOMM Incorporated, San Diego, CA (US)

(72) Inventors: Kazuki TAKEDA, Minato-ku (JP); Valentin Alexandru GHEORGHIU, Yokohama-shi (JP)

(21) Appl. No.: 19/044,284

(22) Filed: Feb. 3, 2025

(51) Int. Cl. H04W 72/1273; H04W 72/0446

(52) U.S. Cl. CPC H04W 72/1273; H04W 72/0446

(57) ABSTRACT

Methods, systems, and devices for wireless communications at a user equipment (UE) are described. The UE may receive, in accordance with a carrier aggregation scheme, first control signaling indicating a first cell associated with transmission and reception at the UE and a second cell associated with reception at the UE. The UE may receive second control signaling indicating a switching pattern for the first and second cell, the switching pattern including first time resources allocated for communication via the first cell and second time resources allocated for communication via the second cell. The UE may receive an activation message to activate a carrier associated with the second cell, and may communicate according to the switching pattern. The UE may transmit an uplink feedback message, where a quantity of bits associated with the uplink feedback message may be based on the first time resources being different from the second time resources.

### FIELD OF TECHNOLOGY

The following relates to wireless communications at a user equipment (UE), including physical layer procedures for carrier aggregation switching.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The systems, methods, and devices of this disclosure each have several innovative aspects, no single one of which is solely responsible for the desirable attributes disclosed herein.

A method for wireless communications by a user equipment (UE) is described. The method may include receiving, in accordance with a carrier aggregation scheme, first control signaling indicating a first cell associated with transmission and reception at the UE and indicating a second cell associated with reception at the UE, receiving second control signaling indicating a switching pattern for the first cell and the second cell, where the switching pattern includes one or more first time resources allocated for communication via the first cell and one or more second time resources allocated for communication via the second cell, and where the one or more first time resources are different from the one or more second time resources, receiving one or more first downlink scheduling messages via the first cell in accordance with the one or more first time resources, one or more second downlink scheduling messages via the second cell in accordance with the one or more second time resources, or both, and transmitting, in accordance with receiving the one or more first downlink scheduling messages, the one or more second downlink scheduling messages, or both, an uplink feedback message, where a quantity of bits associated with the uplink feedback message is based on the one or more first time resources being different from the one or more second time resources.

A UE for wireless communications is described. The UE may include one or more memories storing processor executable code, and one or more processors coupled with the one or more memories. The one or more processors may individually or collectively be operable to execute the code to cause the UE to receive, in accordance with a carrier aggregation scheme, first control signaling indicating a first cell associated with transmission and reception at the UE and indicating a second cell associated with reception at the UE, receive second control signaling indicating a switching pattern for the first cell and the second cell, where the switching pattern includes one or more first time resources allocated for communication via the first cell and one or more second time resources allocated for communication via the second cell, and where the one or more first time resources are different from the one or more second time resources, receive one or more first downlink scheduling messages via the first cell in accordance with the one or more first time resources, one or more second downlink scheduling messages via the second cell in accordance with the one or more second time resources, or both, and transmit, in accordance with receiving the one or more first downlink scheduling messages, the one or more second downlink scheduling messages, or both, an uplink feedback message, where a quantity of bits associated with the uplink feedback message is based on the one or more first time resources being different from the one or more second time resources.

Another UE for wireless communications is described. The UE may include means for receiving, in accordance with a carrier aggregation scheme, first control signaling indicating a first cell associated with transmission and reception at the UE and indicating a second cell associated with reception at the UE, means for receiving second control signaling indicating a switching pattern for the first cell and the second cell, where the switching pattern includes one or more first time resources allocated for communication via the first cell and one or more second time resources allocated for communication via the second cell, and where the one or more first time resources are different from the one or more second time resources, means for receiving one or more first downlink scheduling messages via the first cell in accordance with the one or more first time resources, one or more second downlink scheduling messages via the second cell in accordance with the one or more second time resources, or both, and means for transmitting, in accordance with receiving the one or more first downlink scheduling messages, the one or more second downlink scheduling messages, or both, an uplink feedback message, where a quantity of bits associated with the uplink feedback message is based on the one or more first time resources being different from the one or more second time resources.

A non-transitory computer-readable medium storing code for wireless communications is described. The code may include instructions executable by one or more processors to receive, in accordance with a carrier aggregation scheme, first control signaling indicating a first cell associated with transmission and reception at the UE and indicating a second cell associated with reception at the UE, receive second control signaling indicating a switching pattern for the first cell and the second cell, where the switching pattern includes one or more first time resources allocated for communication via the first cell and one or more second time resources allocated for communication via the second cell, and where the one or more first time resources are different from the one or more second time resources, receive one or more first downlink scheduling messages via the first cell in accordance with the one or more first time resources, one or more second downlink scheduling messages via the second cell in accordance with the one or more second time resources, or both, and transmit, in accordance with receiving the one or more first downlink scheduling messages, the one or more second downlink scheduling messages, or both, an uplink feedback message, where a quantity of bits associated with the uplink feedback message is based on the one or more first time resources being different from the one or more second time resources.

In some examples of the method, UEs, and non-transitory computer-readable medium described herein, the quantity of bits may be two bits, the two bits associated with a counter downlink assignment index (DAI) field of the one or more first downlink scheduling messages, the one or more second downlink scheduling messages, or both.

In some examples of the method, UEs, and non-transitory computer-readable medium described herein, the quantity of bits may be four bits and two bits of the quantity of bits may be associated with a counter DAI field of the one or more first downlink scheduling messages, the one or more second downlink scheduling messages, or both and two bits of the quantity of bits may be associated with a total DAI field of the one or more first downlink scheduling messages, the one or more second downlink scheduling messages, or both.

In some examples of the method, UEs, and non-transitory computer-readable medium described herein, the one or more first downlink scheduling messages may be received via the first cell in accordance with the one or more first time resources and transmitting the uplink feedback message may include operations, features, means, or instructions for transmitting the uplink feedback message via the first cell in accordance with the one or more first time resources.

In some examples of the method, UEs, and non-transitory computer-readable medium described herein, the one or more first downlink scheduling messages may be received in accordance with at least one first time resource of the one or more first time resources and transmitting the uplink feedback message may include operations, features, means, or instructions for transmitting the uplink feedback message via the first cell in accordance with at least one second time resource of the one or more first time resources, where the at least one first time resource may be separated from the at least one second time resource by at least one time resource of the one or more second time resources.

Some examples of the method, UEs, and non-transitory computer-readable medium described herein may further include operations, features, means, or instructions for communicating, in accordance with the one or more first downlink scheduling messages, one or more scheduled downlink messages, one or more scheduled uplink messages, or both via the first cell in accordance with the one or more first time resources, where transmission of the uplink feedback message may be in accordance with communicating the one or more scheduled downlink messages, the one or more scheduled uplink messages, or both.

In some examples of the method, UEs, and non-transitory computer-readable medium described herein, the one or more first downlink scheduling messages may be received in accordance with at least one first time resource of the one or more first time resources and communicating the one or more scheduled downlink messages, the one or more scheduled uplink messages, or both may include operations, features, means, or instructions for communicating the one or more scheduled downlink messages, the one or more scheduled uplink messages, or both via the first cell in accordance with at least one second time resource of the one or more first time resources, where the at least one first time resource may be separated from the at least one second time resource by at least one time resource of the one or more second time resources.

In some examples of the method, UEs, and non-transitory computer-readable medium described herein, the one or more second downlink scheduling messages may be received via the second cell in accordance with the one or more second time resources and transmitting the uplink feedback message may include operations, features, means, or instructions for transmitting the uplink feedback message via the first cell in accordance with the one or more first time resources.

Some examples of the method, UEs, and non-transitory computer-readable medium described herein may further include operations, features, means, or instructions for receiving, in accordance with the one or more second downlink scheduling messages, one or more scheduled downlink messages via the second cell in accordance with the one or more second time resources, where transmission of the uplink feedback message may be in accordance with the reception of the one or more scheduled downlink messages.

In some examples of the method, UEs, and non-transitory computer-readable medium described herein, the one or more first downlink scheduling messages may be received in accordance with at least one first time resource of the one or more second time resource and receiving the one or more scheduled downlink messages may include operations, features, means, or instructions for receiving the one or more scheduled downlink messages via the second cell in accordance with at least one second time resource of the one or more second time resources, where the at least one first time resource may be separated from the at least one second time resource by at least one time resource of the one or more first time resources.

A method for wireless communications by a UE is described. The method may include receiving, in accordance with a carrier aggregation scheme, first control signaling indicating a first cell associated with transmission and reception at the UE and indicating a second cell associated with reception at the UE, receiving second control signaling indicating a switching pattern for the first cell and the second cell, where the switching pattern includes one or more first time resources allocated for communication via the first cell and one or more second time resources allocated for communication via the second cell, and where the one or more first time resources are different from the one or more second time resources, receiving an activation message indicating to activate a downlink carrier associated with the second cell, and communicating, in accordance with the switching pattern and in accordance with receiving the activation message, via the first cell using a first portion of the one or more first time resources and via the second cell using a second portion of the one or more second time resources.

A UE for wireless communications is described. The UE may include one or more memories storing processor executable code, and one or more processors coupled with the one or more memories. The one or more processors may individually or collectively be operable to execute the code to cause the UE to receive, in accordance with a carrier aggregation scheme, first control signaling indicating a first cell associated with transmission and reception at the UE and indicating a second cell associated with reception at the UE, receive second control signaling indicating a switching pattern for the first cell and the second cell, where the switching pattern includes one or more first time resources allocated for communication via the first cell and one or more second time resources allocated for communication via the second cell, and where the one or more first time resources are different from the one or more second time resources, receive an activation message indicating to activate a downlink carrier associated with the second cell, and communicate, in accordance with the switching pattern and in accordance with receiving the activation message, via the first cell using a first portion of the one or more first time resources and via the second cell using a second portion of the one or more second time resources.

Another UE for wireless communications is described. The UE may include means for receiving, in accordance with a carrier aggregation scheme, first control signaling indicating a first cell associated with transmission and reception at the UE and indicating a second cell associated with reception at the UE, means for receiving second control signaling indicating a switching pattern for the first cell and the second cell, where the switching pattern includes one or more first time resources allocated for communication via the first cell and one or more second time resources allocated for communication via the second cell, and where the one or more first time resources are different from the one or more second time resources, means for receiving an activation message indicating to activate a downlink carrier associated with the second cell, and means for communicating, in accordance with the switching pattern and in accordance with receiving the activation message, via the first cell using a first portion of the one or more first time resources and via the second cell using a second portion of the one or more second time resources.

A non-transitory computer-readable medium storing code for wireless communications is described. The code may include instructions executable by one or more processors to receive, in accordance with a carrier aggregation scheme, first control signaling indicating a first cell associated with transmission and reception at the UE and indicating a second cell associated with reception at the UE, receive second control signaling indicating a switching pattern for the first cell and the second cell, where the switching pattern includes one or more first time resources allocated for communication via the first cell and one or more second time resources allocated for communication via the second cell, and where the one or more first time resources are different from the one or more second time resources, receive an activation message indicating to activate a downlink carrier associated with the second cell, and communicate, in accordance with the switching pattern and in accordance with receiving the activation message, via the first cell using a first portion of the one or more first time resources and via the second cell using a second portion of the one or more second time resources.

Some examples of the method, UEs, and non-transitory computer-readable medium described herein may further include operations, features, means, or instructions for activating the downlink carrier associated with the second cell in accordance with receiving the activation message.

Some examples of the method, UEs, and non-transitory computer-readable medium described herein may further include operations, features, means, or instructions for communicating in accordance with the switching pattern occurs a time gap after activation of the downlink carrier associated with the second cell.

Some examples of the method, UEs, and non-transitory computer-readable medium described herein may further include operations, features, means, or instructions for deactivating the downlink carrier associated with the second cell and communicating, in accordance with the deactivation of the downlink carrier, via the first cell using a third portion of the one or more first time resources and using a fourth portion of the one or more second time resources.

Some examples of the method, UEs, and non-transitory computer-readable medium described herein may further include operations, features, means, or instructions for receiving a deactivation message including a deactivation indication, where deactivating the downlink carrier associated with the second cell may be in accordance with receiving the deactivation indication.

In some examples of the method, UEs, and non-transitory computer-readable medium described herein, the deactivation message may be a medium access control-control element (MAC-CE) message.

Some examples of the method, UEs, and non-transitory computer-readable medium described herein may further include operations, features, means, or instructions for deactivating the downlink carrier associated with the second cell may be in accordance with a threshold period of time passing.

Some examples of the method, UEs, and non-transitory computer-readable medium described herein may further include operations, features, means, or instructions for communicating in accordance with the deactivation of the downlink carrier occurs a time gap after deactivation of the downlink carrier.

In some examples of the method, UEs, and non-transitory computer-readable medium described herein, the activation message may be a MAC-CE message.

Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIGS. 1 and 2 show examples of wireless communications systems that support physical (PHY) layer procedures for carrier aggregation switching in accordance with one or more aspects of the present disclosure.

FIGS. 3 and 4 show example of timing diagrams that support PHY layer procedures for carrier aggregation switching in accordance with one or more aspects of the present disclosure.

FIGS. 5 and 6 show examples of a process flows that support PHY layer procedures for carrier aggregation switching in accordance with one or more aspects of the present disclosure.

FIGS. 7 and 8 show block diagrams of devices that support PHY layer procedures for carrier aggregation switching in accordance with one or more aspects of the present disclosure.

FIG. 9 shows a block diagram of a communications manager that supports PHY layer procedures for carrier aggregation switching in accordance with one or more aspects of the present disclosure.

FIG. 10 shows a diagram of a system including a device that supports PHY layer procedures for carrier aggregation switching in accordance with one or more aspects of the present disclosure.

FIGS. 11 through 13 show flowcharts illustrating methods that support PHY layer procedures for carrier aggregation switching in accordance with one or more aspects of the present disclosure.

### DETAILED DESCRIPTION

In some wireless communications systems, a user equipment (UE) may communicate with multiple cells configured for communication. For example, a UE may communicate using carrier aggregation and may receive multiple downlink transmissions via different downlink carriers in different cells at the same time. In other examples, a UE may receive multiple downlink transmissions via different downlink carriers at different times by switching between different cells. In some cases, an example of this may be carrier aggregation via switching, such as low-band switching for carrier aggregation. For example, a first cell may be a full division duplex (FDD) cell, which may include an FDD carrier (e.g., Case 1). The FDD carrier may include uplink and downlink resources (e.g., the UE may be able to transmit and receive simultaneously via the FDD carrier). A second cell may be a supplementary downlink (SDL) cell, which may include an SDL carrier (e.g., Case 2). The UE may switch between communicating via the FDD cell using the FDD carrier and the SDL cell using the SDL carrier, performing carrier aggregation across time. This switching may necessitate some implementation at the physical (PHY) layer of the UE. That is, the UE may implement some PHY layer procedures to perform the switching.

The techniques describes herein support PHY layer procedures for implementing a switching pattern between an FDD cell and an SDL cell. For example, each cell may be monitored, via the associated carriers, by the UE for scheduling physical downlink control channel (PDCCH) messages (e.g., scheduling messages), which may schedule physical downlink shared channels (PDSCH), physical uplink shared channels (PUSCH), or both in the same switching duration during which the PDCCH messages may be received, or in some future switching duration (e.g., a duration in the same cell as that in which the PDCCH may be received, but separated from the switching duration associated with the PDCCH by some switching duration associated with the other cell). As the SDL cell may not support uplink messages, any uplink feedback messages associated with the SDL cell may be transmitted via the FDD cell.

In some implementations, a wireless communications system implementing the switching pattern may have multiple cells configured (e.g., carrier aggregation), but only one cell may be used at a time. That is, the switching pattern is implemented such that the FDD cell and the SDL cell are not used simultaneously. The PHY layer procedures associated with the switching pattern may thus be based on some parameters associated with single serving cells, rather than operations associated with two or more configured serving cells. For example, a quantity of bits for a downlink assignment index (DAI) field in downlink scheduling messages associated with the switching pattern may be the same as for a single serving cell, which may be less bits than for an operation with two serving cells. This may save communication resources and reduce power consumption.

In some implementations, an SDL carrier associated with the SDL cell may be deactivated, such as based on some time period elapsing or based on receiving a deactivation message. The UE may be unable to use the SDL cell, even if the switching pattern is in effect. The UE may ignore the switching pattern and instead communicate via the FDD cell if the SDL carrier is deactivated. In some examples, the UE may ignore the switching pattern after some time gap elapses after the carrier deactivation. In some cases, the UE may receive an activation message re-activating the SDL carrier. The UE may re-implement the switching pattern based on the activation message. In some examples, the UE may implement the switching pattern after some time gap elapses after the carrier activation.

Aspects of the disclosure are initially described in the context of wireless communications systems, timing diagrams, and process flows. Aspects of the disclosure are further illustrated by and described with reference to apparatus diagrams, system diagrams, and flowcharts that relate to PHY layer procedures for carrier aggregation switching.

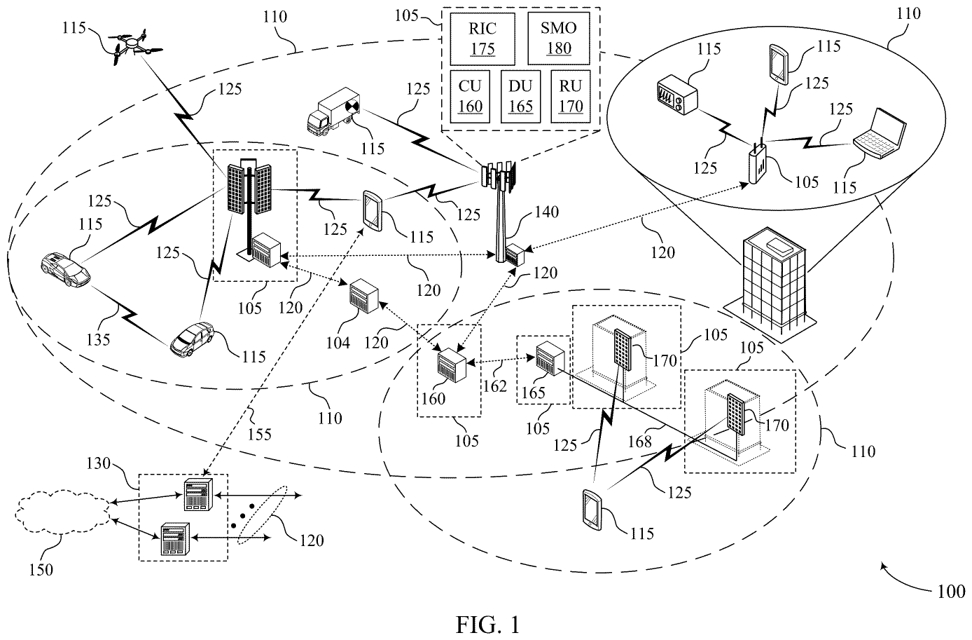

FIG. 1 shows an example of a wireless communications system 100 that supports PHY layer procedures for carrier aggregation switching in accordance with one or more aspects of the present disclosure. The wireless communications system 100 may include one or more devices, such as one or more network devices (e.g., network entities 105), one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via communication link(s) 125 (e.g., a radio frequency (RF) access link). For example, a network entity 105 may support a coverage area 110 (e.g., a geographic coverage area) over which the UEs 115 and the network entity 105 may establish the communication link(s) 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices in the wireless communications system 100 (e.g., other wireless communication devices, including UEs 115 or network entities 105), as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with a core network 130, or with one another, or both. For example, network entities 105 may communicate with the core network 130 via backhaul communication link(s) 120 (e.g., in accordance with an S1, N2, N3, or other interface protocol). In some examples, network entities 105 may communicate with one another via backhaul communication link(s) 120 (e.g., in accordance with an X2, Xn, or other interface protocol) either directly (e.g., directly between network entities 105) or indirectly (e.g., via the core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication link(s) 120, midhaul communication links 162, or fronthaul communication links 168 may be or include one or more wired links (e.g., an electrical link, an optical fiber link) or one or more wireless links (e.g., a radio link, a wireless optical link), among other examples or various combinations thereof. A UE 115 may communicate with the core network 130 via a communication link 155.

One or more of the network entities 105 or network equipment described herein may include or may be referred to as a base station 140 (e.g., a base transceiver station, a radio base station, an NR base station, an access point, a radio transceiver, a NodeB, an eNodeB (eNB), a next-generation NodeB or giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within one network entity (e.g., a network entity 105 or a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among multiple network entities (e.g., network entities 105), such as an integrated access and backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU), such as a CU 160, a distributed unit (DU), such as a DU 165, a radio unit (RU), such as an RU 170, a RAN Intelligent Controller (RIC), such as an RIC 175 (e.g., a Near-Real Time RIC (Near-RT RIC), a Non-Real Time RIC (Non-RT RIC)), a Service Management and Orchestration (SMO) system, such as an SMO system 180, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more of the network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, or any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaptation protocol (SDAP), Packet Data Convergence Protocol (PDCP)). The CU 160 (e.g., one or more CUs) may be connected to a DU 165 (e.g., one or more DUs) or an RU 170 (e.g., one or more RUs), or some combination thereof, and the DUs 165, RUs 170, or both may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or multiple different RUs, such as an RU 170). In some cases, a functional split between a CU 160 and a DU 165 or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to a DU 165 via a midhaul communication link 162 (e.g., F1, F1-c, F1-u), and a DU 165 may be connected to an RU 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities (e.g., one or more of the network entities 105) that are in communication via such communication links.

In some wireless communications systems (e.g., the wireless communications system 100), infrastructure and spectral resources for radio access may support wireless backhaul link capabilities to supplement wired backhaul connections, providing an IAB network architecture (e.g., to a core network 130). In some cases, in an IAB network, one or more of the network entities 105 (e.g., network entities 105 or IAB node(s) 104) may be partially controlled by each other. The IAB node(s) 104 may be referred to as a donor entity or an IAB donor. A DU 165 or an RU 170 may be partially controlled by a CU 160 associated with a network entity 105 or base station 140 (such as a donor network entity or a donor base station). The one or more donor entities (e.g., IAB donors) may be in communication with one or more additional devices (e.g., IAB node(s) 104) via supported access and backhaul links (e.g., backhaul communication link(s) 120). IAB node(s) 104 may include an IAB mobile termination (IAB-MT) controlled (e.g., scheduled) by one or more DUs (e.g., DUs 165) of a coupled IAB donor. An IAB-MT may be equipped with an independent set of antennas for relay of communications with UEs 115 or may share the same antennas (e.g., of an RU 170) of IAB node(s) 104 used for access via the DU 165 of the IAB node(s) 104 (e.g., referred to as virtual IAB-MT (vIAB-MT)). In some examples, the IAB node(s) 104 may include one or more DUs (e.g., DUs 165) that support communication links with additional entities (e.g., IAB node(s) 104, UEs 115) within the relay chain or configuration of the access network (e.g., downstream). In such cases, one or more components of the disaggregated RAN architecture (e.g., the IAB node(s) 104 or components of the IAB node(s) 104) may be configured to operate according to the techniques described herein.

In the case of the techniques described herein applied in the context of a disaggregated RAN architecture, one or more components of the disaggregated RAN architecture may be configured to support PHY layer procedures for carrier aggregation switching as described herein. For example, some operations described as being performed by a UE 115 or a network entity 105 (e.g., a base station 140) may additionally, or alternatively, be performed by one or more components of the disaggregated RAN architecture (e.g., components such as an IAB node, a DU 165, a CU 160, an RU 170, an RIC 175, an SMO system 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, vehicles, or meters, among other examples.

The UEs 115 described herein may be able to communicate with various types of devices, such as UEs 115 that may sometimes operate as relays, as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via the communication link(s) 125 (e.g., one or more access links) using resources associated with one or more carriers. The term “carrier” may refer to a set of RF spectrum resources having a defined PHY layer structure for supporting the communication link(s) 125. For example, a carrier used for the communication link(s) 125 may include a portion of an RF spectrum band (e.g., a bandwidth part (BWP)) that is operated according to one or more PHY layer channels for a given RAT (e.g., LTE, LTE-A, LTE-A Pro, NR). Each PHY layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities, such as one or more of the network entities 105).

In some examples, such as in a carrier aggregation configuration, a carrier may have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be identified according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different RAT).

The communication link(s) 125 of the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular RAT (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications using a particular carrier bandwidth or may be configurable to support communications using one of a set of carrier bandwidths. In some examples, the wireless communications system 100 may include network entities 105 or UEs 115 that support concurrent communications using carriers associated with multiple carrier bandwidths. In some examples, each served UE 115 may be configured for operating using portions (e.g., a sub-band, a BWP) or all of a carrier bandwidth.

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems, such as the wireless communications system 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to UEs 115 (e.g., one or more UEs) or may include UE-specific search space sets for sending control information to a UE 115 (e.g., a specific UE).

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., using a carrier) and may be associated with an identifier for distinguishing neighboring cells (e.g., a physical cell identifier (PCID), a virtual cell identifier (VCID)). In some examples, a cell also may refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a network entity 105 operating with lower power (e.g., a base station 140 operating with lower power) relative to a macro cell, and a small cell may operate using the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or more cells and may also support communications via the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area, such as the coverage area 110. In some examples, coverage areas 110 (e.g., different coverage areas) associated with different technologies may overlap, but the coverage areas 110 (e.g., different coverage areas) may be supported by the same network entity (e.g., a network entity 105). In some other examples, overlapping coverage areas, such as a coverage area 110, associated with different technologies may be supported by different network entities (e.g., the network entities 105). The wireless communications system 100 may include, for example, a heterogeneous network in which different types of the network entities 105 support communications for coverage areas 110 (e.g., different coverage areas) using the same or different RATs.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs (e.g., one or more of the UEs 115) via a device-to-device (D2D) communication link, such as a D2D communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to one or more of the UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than one hundred kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) RAT, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

The UEs 115 and the network entities 105 may support retransmissions of data to increase the likelihood that data is received successfully. Hybrid automatic repeat request (HARQ) feedback is one technique for increasing the likelihood that data is received correctly via a communication link (e.g., the communication link(s) 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in relatively poor radio conditions (e.g., low signal-to-noise conditions). In some examples, a device may support same-slot HARQ feedback, in which case the device may provide HARQ feedback in a specific slot for data received via a previous symbol in the slot. In some other examples, the device may provide HARQ feedback in a subsequent slot, or according to some other time interval.

In some wireless communications systems 100, a UE 115 may communicate with multiple cells configured for communication. For example, a UE 115 may communicate using carrier aggregation and may receive multiple downlink transmissions via different downlink carriers in different cells at the same time. In other examples, a UE 115 may receive multiple downlink transmissions via different downlink carriers at different times by switching between different cells. In some cases, an example of this may be carrier aggregation via switching, such as low-band switching for carrier aggregation. For example, a first cell may be a FDD cell, which may include an FDD carrier (e.g., case 1). The FDD carrier may include uplink and downlink resources (e.g., the UE 115 may be able to transmit and receive simultaneously via the FDD carrier). A second cell may be a SDL cell, which may include an SDL carrier (e.g., case 2). The UE 115 may switch between communicating via the FDD cell using the FDD carrier and the SDL cell using the SDL carrier, performing carrier aggregation across time. This switching may necessitate some implementation at the PHY layer of the UE 115. That is, the UE 115 may implement some PHY layer procedures to perform the switching.

The techniques describes herein support PHY layer procedures for implementing a switching pattern between an FDD cell and an SDL cell. For example, each cell may be monitored, via the associated carriers, by the UE 115 for scheduling PDCCH messages (e.g., scheduling messages), which may schedule PDSCH, PUSCH, or both in the same switching duration during which the PDCCH messages may be received, or in some future switching duration (e.g., a duration in the same cell as that in which the PDCCH may be received, but separated from the switching duration associated with the PDCCH by some switching duration associated with the other cell). As the SDL cell may not support uplink messages, any uplink feedback messages associated with the SDL cell may be transmitted via the FDD cell.

In some implementations, a wireless communications system 100 implementing the switching pattern may have multiple cells configured (e.g., carrier aggregation), but only one cell may be used at a time. That is, the switching pattern may be implemented such that the FDD cell and the SDL cell may not be used simultaneously. The PHY layer procedures associated with the switching pattern may thus be based on some parameters associated with single serving cells, rather than operations associated with two or more configured serving cells. For example, a quantity of bits for a DAI field in downlink scheduling messages associated with the switching pattern may be the same as for a single serving cell, which may be less bits than for an operation with two serving cells. This may save communication resources and reduce power consumption.

In some implementations, an SDL carrier associated with the SDL cell may be deactivated, such as based on some time period elapsing or based on receiving a deactivation message. The UE 115 may be unable to use the SDL cell, even if the switching pattern is in effect. The UE 115 may ignore the switching pattern and instead communicate via the FDD cell if the SDL carrier is deactivated. In some examples, the UE 115 may ignore the switching pattern after some time gap elapses after the carrier deactivation. In some cases, the UE 115 may receive an activation message re-activating the SDL carrier. The UE 115 may re-implement the switching pattern based on the activation message. In some examples, the UE 115 may implement the switching pattern after some time gap elapses after the carrier activation.

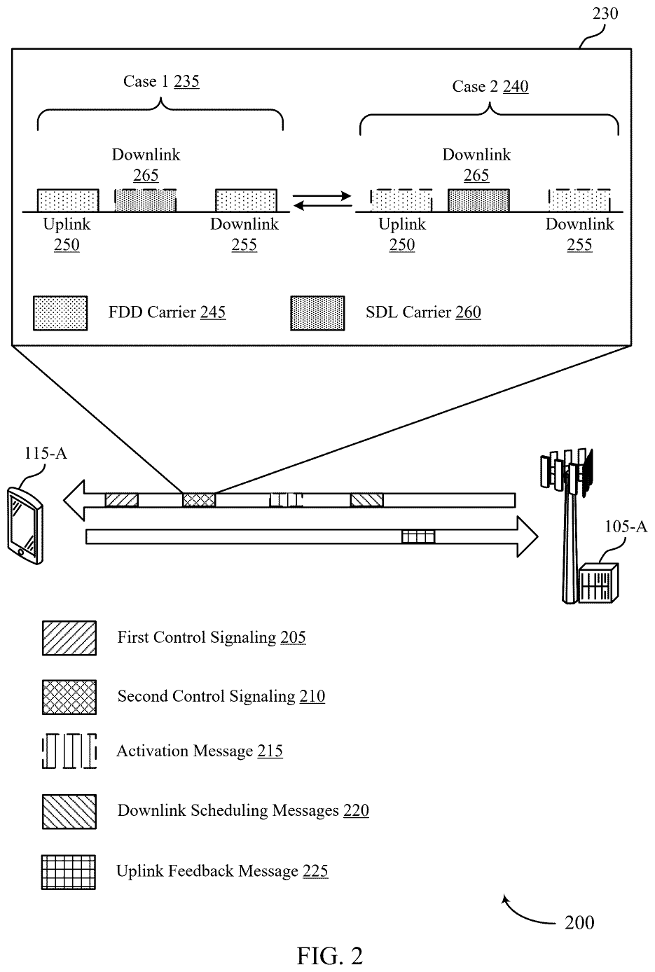

FIG. 2 shows an example of a wireless communications system 200 that supports PHY layer procedures for carrier aggregation switching in accordance with one or more aspects of the present disclosure. The wireless communications system 200 may implement, or be implemented by, aspects of the wireless communications system 100. For example, the wireless communications system 200 may include one or more network entities 105 and one or more UEs 115, including at least the network entity 105-a and UE 115-a, which may be examples of corresponding devices as described herein, including with reference to FIG. 1. The techniques described herein in the context of the wireless communications system 200 may support implementing PHY layer procedures for using a switching pattern between an FDD cell and an SDL cell.

In some wireless communications systems 200, carrier aggregation schemes, such as low-band switching (e.g., switching for low frequency bands) for carrier aggregation, may be supported. In some implementations, a network entity 105-a may transmit first control signaling 205. The first control signaling 205 may, in accordance with a carrier aggregation scheme, indicate a first cell associated with transmission and reception at the UE (e.g., an FDD cell) and a second cell associated with reception at the UE (e.g., an SDL cell). The network entity 105-a may transmit second control signaling 210, which may indicate a switching pattern 230 (e.g., semi-static switching pattern 230).

The switching pattern 230 may be a switching pattern for the FDD cell and the SDL cell. The switching pattern may include one or more first time resources allocated for communication via the FDD cell and one or more second time resources allocated for communication via the SDL cell. The one or more first time resources may be different from the one or more second time resources. For example, the switching pattern 230 may enable switching between case 1 durations 235, which may include communicating via the FDD cell, and case 2 durations 240, which may include communicating via the SDL cell. In case 1 durations 235, the UE 115-a may communicate in the FDD cell using an FDD carrier 245, which may include an uplink 250 and a downlink 255. The UE 115-a may not use the downlink 265 associated with the SDL cell. In case 2 durations 240, the UE 115-a may communicate in the SDL cell using an SDL carrier 260, which may be the downlink 265. The UE 115-a may not use the uplink 250 or the downlink 255 associated with the FDD carrier 245.

In some cases, there may be some switching gap, or a time gap, to allow for switching between case 1 durations 235 and case 2 durations 240. That is, there may be some switching period where no communication may occur. In some cases, this may be a switching delay, and may be preconfigured or indicated in the first control signaling 205, the second control signaling 210, or both. During the switching period, the UE 115-a may be unable to transmit or receive on either or both the FDD carrier 245 or the SDL carrier 260. In some cases, there may be some time mask for carrier switching associated with the switching pattern 230 that may be preconfigured or indicated in the first control signaling 205, the second control signaling 210, or both. In some cases, some radio resource management (RRM) parameters associated with the switching pattern 230 may be preconfigured or indicated in the first control signaling 205, the second control signaling 210, or both. In some cases, the UE 115-a may have some capabilities associated with implementing the switching pattern 230. In some cases, the UE 115-a may implement the switching pattern 230 under some carrier constraints. For example, the carrier frequency for case 1 durations 235 and case 2 durations 240 may be below a threshold (e.g., 1 GHz). In some examples, there may be some co-located or synchronized network deployment for the FDD carrier 245 and the SDL carrier 260. In some examples, the FDD carrier 245 and the SDL carrier 260 may be in the same timing advance group (TAG). A subcarrier spacing for the FDD carrier 245, the SDL carrier 260, or both may be some value (e.g., 15 kHz). In some cases, the carrier aggregation scheme may be associated with some band combination (e.g., CA_n5A-n29A).

In some implementations, the UE 115-a may be configured (e.g., via radio resource control (RRC) signaling) with a semi-static switching pattern (e.g., switching pattern 230). For example, the UE 115-a may receive the second control signaling 210 indicating or configuring the switching pattern 230. The switching pattern 230 may enable switching between the FDD cell and the SDL cell, or between case 1 durations 235 and case 2 durations 240. That is, the UE 115-a and the network entity 105-a may switch between operating using an FDD carrier 245 and an SDL carrier 260. In some cases, there may be a switching gap (e.g., time gap) for the UE 115-a to switch between case 1 durations 235 and case 2 durations 240.

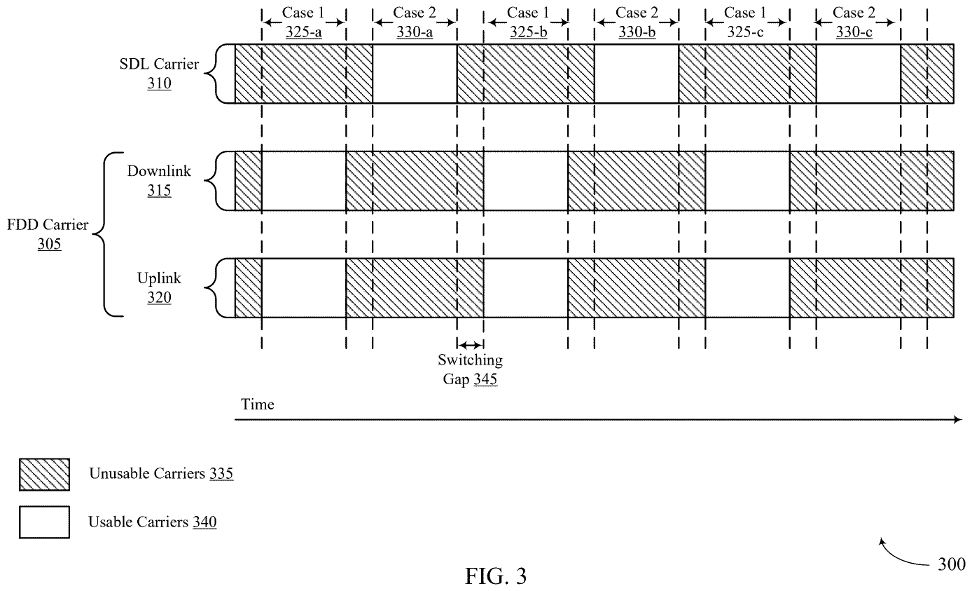

In some implementations, as described further with reference to FIG. 3, a wireless communications system implementing the switching pattern 230 may have multiple cells configured (e.g., carrier aggregation), but only one cell may be used at a time. That is, the switching pattern 230 may be implemented such that the FDD cell and the SDL cell are not used simultaneously. The PHY layer procedures associated with the switching pattern 230 may thus be based on some parameters associated with single serving cells, rather than operations associated with two or more configured serving cells. For example, a quantity of bits for a DAI field associated with an uplink feedback message 225 may be the same as for a single serving cell, which may be less bits than for an operation with two serving cells. That is, the UE 115-a may receive some downlink scheduling messages 220 (e.g., DCI) in accordance with the switching pattern 230 (e.g., via first resources associated with the FDD cell or via second resource associated with the SDL cell). Each downlink scheduling message (e.g., DCI) may include a counter DAI field and, in some cases, a total DAI field. The counter DAI field may count a quantity of scheduling messages that may be indicated in the uplink feedback message 225. The UE 115-a may transmit uplink feedback message 225 to indicate successful reception of the downlink scheduling messages 220 based on the quantity of bits associated with the DAI. The quantity of bits for the DAI may be reduced or equivalent to a quantity of bits for a DAI associated with an

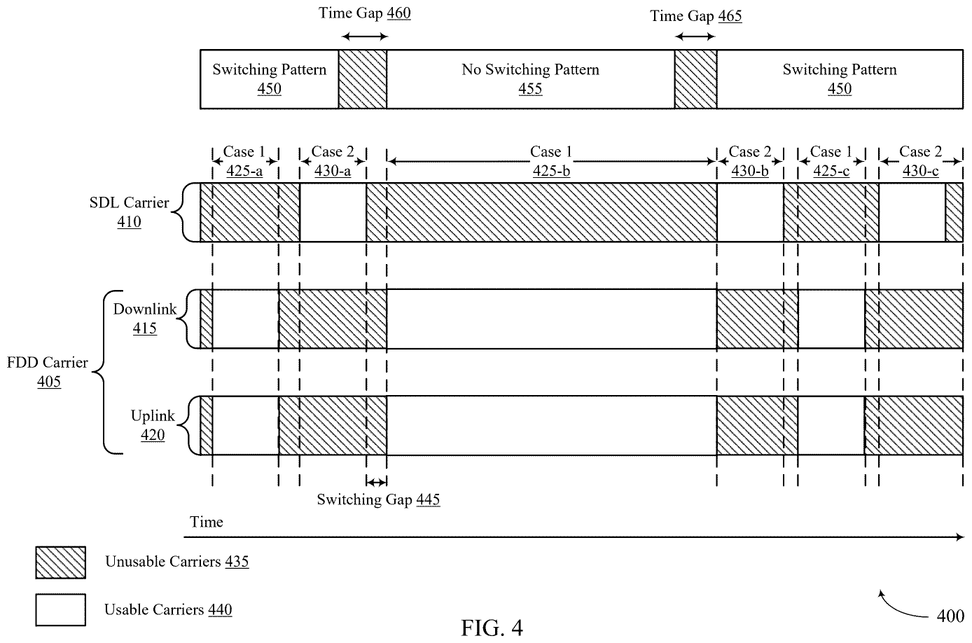

In some implementations, as described further with reference to FIG. 4, the SDL carrier 260 may be deactivated, such as based on some time period elapsing or based on receiving a deactivation message. The UE 115-a may be unable to use the SDL cell, even if the switching pattern 230 is in effect. The UE 115-a may ignore the switching pattern 230 and instead communicate via the FDD cell if the SDL carrier 260 is deactivated (e.g., via case 1 durations 235). In some examples, the UE 115-a may ignore the switching pattern 230 after some time gap elapses after the SDL carrier 260 deactivation. In some cases, the UE 115-a may receive an activation message 215 re-activating the SDL carrier 260. The UE 115-a may re-implement the switching pattern based on the activation message 215, such as for receiving downlink scheduling messages 220 and transmitting uplink feedback message 225. In some examples, the UE 115-a may implement the switching pattern 230 after some time gap elapses after the SDL carrier 260 activation.

FIG. 3 shows an example of a timing diagram 300 that supports PHY layer procedures for carrier aggregation switching in accordance with one or more aspects of the present disclosure. The timing diagram 300 may implement, or be implemented by, aspects of the wireless communications systems 100 and 200. For example, the timing diagram 300 may include examples of a switching pattern, which may be an example of corresponding patterns as described herein, including with reference to FIG. 2. The techniques described herein in the context of the timing diagram 300 may support implementing PHY layer procedures associated with configuration of a single serving cell for using a switching pattern between an FDD cell and an SDL cell.

In some wireless communications systems, a UE and network entity may communicate according to a switching pattern for carrier aggregation. The network entity may, via control signaling, configure or indicate the switching pattern to the UE. In some cases, the UE may switch between a FDD cell, using an FDD carrier 305, and an SDL cell, using an SDL carrier 310. The FDD carrier 305 may include a downlink 315 and an uplink 320. The SDL carrier 310 may be downlink. Communicating via the FDD cell may be associated with case 1 durations 325, and communicating via the SDL cell may be associated with case 2 durations 330. The UE may not communicate via the FDD cell and the SDL cell simultaneously. For example, when the UE operates according to case 1 durations 325, the SDL carrier 310 may be an unusable carrier 335, while the FDD carrier 305 may be usable (e.g., a usable carrier 340). When the UE operates according to case 2 durations 330, the FDD carrier 305 may be an unusable carrier 335, while the SDL carrier 310 may be usable (e.g., a usable carrier 340). In some cases, there may be some switching gap 345 (e.g., switching period, time gap, threshold time period) associated with switching between case 1 durations 325 and case 2 durations 330. During the switching gap 345, the UE may be unable to transmit or receive on either or both of the FDD carrier 305 or the SDL carrier 310. That is, the FDD carrier 305 and the SDL carrier 310 may be unusable carriers 335.

In some implementations, during case 1 durations 325, the UE may monitor a PDCCH on the FDD carrier 305 for PDCCH messages that may schedule PDSCH or PUSCH on the FDD carrier 305. The PDCCH messages may schedule PDSCH, PUSCH, or both within the same case 1 duration 325 as the PDCCH, or within a different case 1 duration 325. For example, a PDDCH message received during case 1 duration 325-a may schedule a PDSCH, PUSCH, or both within case 1 duration 325-a. Additionally, or alternatively, the PDDCH message received during case 1 duration 325-a may schedule the PDSCH, PUSCH or both within case 1 duration 325-b, case 1 duration 325-c, or both. This may be considered cross-duration scheduling. Cross-duration scheduling may be possible based on cross-slot scheduling mechanisms (e.g., K₀>1, K₂>1). For PDSCH scheduled on the FDD carrier 305, uplink feedback messages (e.g., physical uplink control channel (PUCCH) for HARQ-ACK) may be transmitted via the FDD carrier 305. The uplink feedback messages may be transmitted within the same case 1 duration 325 as the PDDCH message, or within a different case 1 duration 325. The latter may be cross-duration feedback (e.g., cross-duration HARQ-ACK feedback), which may be possible by adjusting (e.g., increasing) values of feedback timing mechanisms (e.g., PDSCH-to-HARQ_feedback timing, K₁>1). In some cases, semi-statically configured downlink receptions (e.g., channel state information (CSI)-reference signal (RS) receptions, tracking reference signal (TRS) receptions, PDSCH receptions) may be performed on the FDD carrier 305 (e.g., via downlink 315). In some cases, semi-statically configured uplink transmissions (e.g., physical random access channel (PRACH) transmissions, PUCCH transmissions, PUSCH transmissions, sounding reference signal (SRS) transmissions) may be performed on the FDD carrier 305.

In some implementations, during case 2 durations 330, the UE may monitor a PDCCH on the SDL carrier 310 for PDCCH messages that may schedule PDSCH on the SDL carrier 310. The PDCCH messages may schedule the PDSCH within the same case 2 duration 330 as the PDCCH, or within a different case 2 durations 330. For example, a PDDCH message received during case 2 duration 330-a may schedule a PDSCH within case 2 duration 330-a. Additionally, or alternatively, the PDDCH message received during case 2 duration 330-a may schedule the PDSCH within case 2 duration 330-b, case 2 duration 330-c, or both. This may be considered cross-duration scheduling. Cross-duration scheduling may be possible based on cross-slot scheduling mechanisms (e.g., K₀>1). In some cases, semi-statically configured downlink receptions (e.g., channel state information (CSI)-reference signal (RS) receptions, tracking reference signal (TRS) receptions, PDSCH receptions) may be performed on the SDL carrier 310. In some cases, uplink feedback messages for PDSCH scheduled on the SDL carrier 310 may be transmitted in a proceeding case 1 duration 325. That is, case 2 durations 330 may support downlink communication and not uplink communication. In order to transmit an uplink feedback message, the UE may transmit the PUCCH for HARQ-ACK associated with the SDL carrier 310 via the FDD carrier 305, which supports uplink transmission via the uplink 320. In some cases, the uplink feedback messages may be transmitted during any case 1 durations 325 after the case 2 duration 330 in which the associated PDCCH messages may be received. In other cases, the uplink feedback messages may be transmitted during the case 1 duration 325 directly after the case 2 duration 330 in which the associated PDCCH messages may be received.

In some implementations, the UE may not monitor or receive downlink transmissions, such as PDCCH messages, on two carriers simultaneously. That is, the UE may switch between the FDD carrier 305 and the SDL carrier 310, and may not use multiple downlink carriers simultaneously. Similarly, the UE may not transmit uplink messages using multiple carriers, as there may be an uplink 320 associated with the FDD carrier 305, but no uplink associated with the SDL carrier 310. Because the UE may not utilize multiple carriers simultaneously in this way, some PHY layer procedures may be defined similarly to operations involving a single serving cell, as only one single serving cell may be used at a time. That is, although multiple serving cells may be configured and implemented, only one serving cell may be used at a time, so PHY layer procedures parameters may be implemented as if the UE may use a single serving cell, rather than two serving cells. This may reduce complexity, processing, and power associated with having multiple cells configured.

In some cases, for example, an uplink feedback codebook may be implemented based on whether carrier aggregation via the switching pattern may be enabled. For example, each DCI format received by the UE (e.g., PDCCH messages) that may schedule a PDSCH may implement a counter DAI field. The counter DAI may count the quantity of DCI formats scheduling PDSCH that may have associated uplink control information to be multiplexed on a PUCCH to provide feedback to the network entity (e.g., HARQ-ACK multiplexing on a PUCCH). In some cases, the DCI formats may also include a total DAI field. In some examples, DAIs may help indicate to a UE if one or more DCI formats are missed or undetected, enabling more robust feedback in the uplink feedback messages. The DAI may count in the frequency-domain and then in the time-domain.

The DAI field may be some quantity of bits (e.g., some bit-width) within the DCI (e.g., DCI format 1_1). In some cases, the quantity of bits may depend on the quantity of serving cells configured for downlink communication. For example, for one serving cell configured in the downlink, the minimum quantity of bits for the DAI field may be 2. For more than one serving cells configured in the downlink, the minimum quantity of bits of the DAI field may be 4. For carrier aggregation with switching, multiple cells may be configured. However, since no downlink cells may be used simultaneously, the DAI bit-width may be related to the condition when only one serving cell is configured. For example, for more than one serving cells configured in the downlink via a switching pattern, the minimum quantity of bits for the DAI field may be 2. In some examples, the total DAI field may also be configured, which may increase the total quantity of bits related to the DAI.

For example, the DAI bit-width may be 6 bits if more than one serving cell is configured in the downlink, a parameter associated with the switching pattern (e.g., RRC parameter [low-band-switch]) is not configured, a higher layer parameter related to including the total DAI (e.g., nfi-TotalDAI-Included) is configured, or any combination thereof. The four most significant bit (MSB) bits may be the counter DAI and the total DAI for a scheduled PDSCH group, and the two least significant bit (LSB) bits may be the total DAI for a non-scheduled PDSCH group. Additionally, or alternatively, the DAI bit-width may be 4 bits if only one serving cell is configured in the downlink, if two serving cells with a parameter associated with the switching pattern (e.g., RRC parameter [low-band-switch]) are configured, a higher layer parameter related to including the total DAI (e.g., nfi-TotalDAI-Included) is configured, or any combination thereof. The two MSB bits may be the counter DAI a scheduled PDSCH group, and the two LSB bits may be the total DAI for a non-scheduled PDSCH group. Additionally, or alternatively, the DAI bit-width may be 4 bits if more than one serving cell is configured in the downlink, a parameter associated with the switching pattern (e.g., RRC parameter [low-band-switch]) is not configured, a higher layer parameter indicating that a codebook may be dynamic is configured (e.g., pdsch-HARQ-ACK-Codebook=dynamic, pdsch-HARQ-ACK-Codebook-r16=enhancedDynamic), a higher layer parameter related to including the total DAI (e.g., nfi-TotalDAI-Included) is not configured, or any combination thereof. The two MSB bits may be the counter DAI, and the two LSB bits may be the total DAI.

Additionally, or alternatively, the DAI bit-width may be 4 bits if one serving cell is configured in the downlink, if two serving cells with a parameter associated with the switching pattern (e.g., RRC parameter [low-band-switch]) are configured, a higher layer parameter indicating that a codebook may be dynamic is configured (e.g., pdsch-HARQ-ACK-Codebook=dynamic, pdsch-HARQ-ACK-Codebook-r16=enhancedDynamic), the UE is not provided a control resource set (CORESET) pool index (e.g., coresetPoolIndex), the UE is provided the CORESET pool index with a value of zero for one or more first CORESETs and is provided a CORESET pool index with a value of one for one or more second CORESETs, a feedback parameter is configured (e.g., ackNackFeedbackMode=joint), or any combination thereof. The two MSB bits may be the counter DAI, and the two LSB bits may be the total DAI. Additionally, or alternatively, the DAI bit-width may be 2 bits if one serving cell is configured in the downlink, if two serving cells with a parameter associated with the switching pattern (e.g., RRC parameter [low-band-switch]) are configured, a higher layer parameter indicating that a codebook may be dynamic is configured (e.g., pdsch-HARQ-ACK-Codebook=dynamic, pdsch-HARQ-ACK-Codebook-r16=enhancedDynamic), the UE is not configured with a CORESET pool index (e.g., coresetPoolIndex), the UE is provided the CORESET pool index with a same value for all CORESETs, a feedback parameter is not configured (e.g., ackNackFeedbackMode=joint), a higher layer parameter related to including the total DAI (e.g., nfi-TotalDAI-Included) is not configured, or any combination thereof. The two bits may be the counter DAI. Otherwise, the DAI bit-width may be zero bits.

FIG. 4 shows an example of a timing diagram 400 that supports PHY layer procedures for carrier aggregation switching in accordance with one or more aspects of the present disclosure. The timing diagram 400 may implement, or be implemented by, aspects of the wireless communications systems 100 and 200, and the timing diagram 300. For example, the timing diagram 400 may include examples of a switching pattern, which may be an example of corresponding patterns as described herein, including with reference to FIGS. 2 and 3. The techniques described herein in the context of the timing diagram 400 may support implementing PHY layer procedures associated with configuration of a single serving cell for using a switching pattern between an FDD cell and an SDL cell based on the activation of an SDL carrier 410.

In some wireless communications systems, as described herein, a UE and network entity may communicate according to a switching pattern 450 between an FDD cell and an SDL cell. That is, the UE may switch between operating with an FDD carrier 405 and an SDL carrier 410. The FDD carrier 405 may include downlink 415 and uplink 420, while the SDL carrier 410 may be downlink. When the UE operates via the FDD cell, the UE may operate according to a case 1 durations 425. During case 1 durations 425, the FDD carrier 405 may be a usable carrier 440 and the SDL carrier 410 may be an unusable carrier 435. When the UE operates via the SDL cell, the UE may operate according to a case 2 durations 430. During case 2 durations 430, the FDD carrier 405 may be an unusable carrier 435 and the SDL carrier 410 may a usable carrier 440. The UE may take some time to switch between the FDD carrier 405 and the SDL carrier 410, which may be the switching gap 445 (e.g., time gap, switching period). During the switching gap, the UE may be unable to communicate via the FDD carrier 405 or the SDL carrier 410 (e.g., both carriers may be unusable carriers 435).

In some implementations, the SDL carrier 410 may be deactivated. In some examples, the network entity may send some deactivation message, which may be a medium access control-control element (MAC-CE) message to deactivate the SDL carrier 410. In other examples, the SDL carrier 410 may deactivate after some period of time, or after a timer (e.g., MAC timer) expires. After the SDL carrier 410 is deactivated, the UE may not be able to communicate during case 2 durations 430. That is, if the switching pattern 450 is implemented, the UE may waste time and resources by not communicating during the case 2 durations 430. Instead, the UE may fallback to single-cell operation via the FDD cell without restrictions created by the switching pattern 450. That is, the UE may operate with no switching pattern 455, or entirely according to case 1duration 425-b. Thus, the switching pattern 450, which may be an RRC configured semi-static switching pattern, may be implemented when the SDL carrier 410 may be active.

For example, when the SDL carrier 410 may be deactivated by a deactivation message or a timer expiration, the UE may ignore the configured switching pattern 450 and may remain in case 1 duration 425-b. In some cases, the UE may implement the no switching pattern 455, some time moment (e.g., time gap 460) after the deactivation of the SDL carrier 410. In some examples, the time gap 460 may be some time period (e.g., 3 ms) after the UE may transmit an uplink feedback message (e.g., ACK) for the PDSCH that may carry the deactivation command (e.g., MAC-CE deactivation command), or some time period (e.g., 3 ms) after the timer expiration. For example, the SDL carrier 410 may be deactivated during case 2 duration 430-a. The UE may, after some time gap 460, begin operating solely according to case 1 duration 425-b.

In some cases, the SDL carrier 410 may be activated or re-activated by an activation message (e.g., MAC-CE message). The UE may return to using the switching pattern 450. In some examples, the UE may implement the switching pattern 450 some time moment (e.g., time gap 465) after the activation of the SDL carrier 410. In some examples, the time gap 465 may be some time period (e.g., 3 ms) after the UE may transmit an uplink feedback message (e.g., an ACK) for the PDSCH that may carry the activation command (e.g., AMC-CE activation command. For example, the SDL carrier 410 may be reactivated during the case 1 duration 425-b. After the time gap 465 has elapsed, the UE may operate according to the switching pattern 450, such as at case 2 duration 430-b.

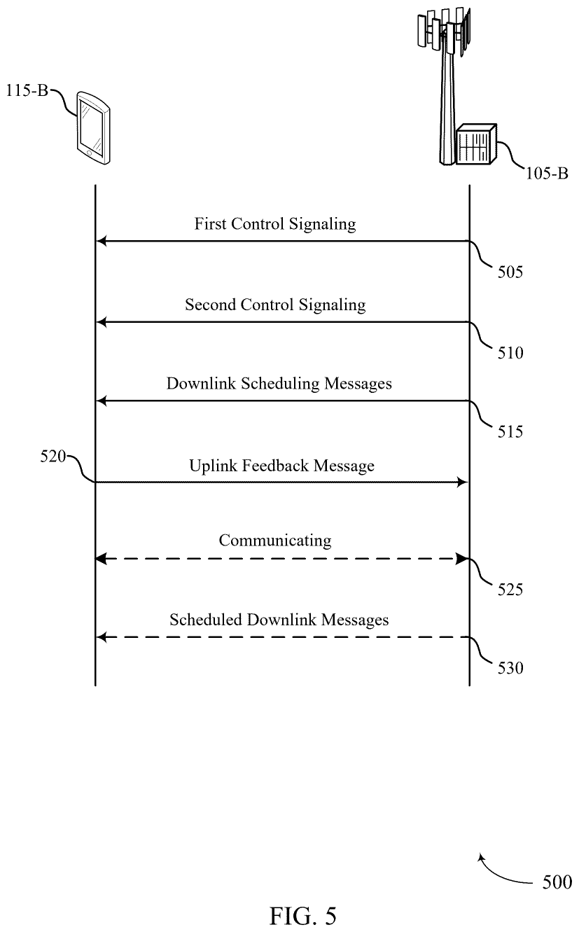

FIG. 5 shows an example of a process flow 500 that supports PHY layer procedures for carrier aggregation switching in accordance with one or more aspects of the present disclosure. The process flow 500 may implement, or be implemented by, aspects of the wireless communications systems 100 and 200, and timing diagrams 300 and 400. For example, the process flow 500 may include one or more network entities 105 and one or more UEs 115, including at least the network entity 105-b and UE 115-b, which may be examples of corresponding devices as described herein, including with reference to FIGS. 1 and 2. The techniques described herein in the context of the process flow 500 may support implementing PHY layer procedures associated with configuration of a single serving cell for using a switching pattern between an FDD cell and an SDL cell.

At 505, the UE 115-b may receive and the network entity 105-b may transmit, in accordance with a carrier aggregation scheme, first control signaling indicating a first cell associated with transmission and reception at the UE 115-b (e.g., an FDD cell) and indicating a second cell associated with reception at the UE 115-b (e.g., an SDL cell).

At 510, the UE 115-b may receive, and the network entity 105-b may transmit, second control signaling indicating a switching pattern for the first cell and the second cell, where the switching pattern may include one or more first time resources allocated for communication via the first cell (e.g., case 1 durations) and one or more second time resources allocated for communication via the second cell (e.g., case 2 durations). The one or more first time resources may be different from the one or more second time resources.

At 515, the UE 115-b may receive, and the network entity 105-b may transmit, one or more first downlink scheduling messages via the first cell in accordance with the one or more first time resources, one or more second downlink scheduling messages via the second cell in accordance with the one or more second time resources, or both. In some cases, the UE 115-b may receive the one or more first downlink scheduling messages via the first cell in accordance with the one or more first time resources. In some examples, the UE 115-b may receive the one or more first downlink scheduling messages in accordance with at least one first time resource of the one or more first time resources. In some cases, the UE 115-b may receive the one or more second downlink scheduling messages via the second cell in accordance with the one or more second time resources.

At 520, the UE 115-b may transmit and the network entity 105-b may receive, in accordance with receiving the one or more first downlink scheduling messages, the one or more second downlink scheduling messages, or both at 515, an uplink feedback message. A quantity of bits associated with the uplink feedback message may be based on the one or more first time resources being different from the one or more second time resources. That is, the one or more downlink scheduling messages (e.g., the one or more first downlink scheduling messages, the one or more second downlink scheduling messages, or both) may include a DAI field that may count a quantity of first downlink scheduling messages that may be multiplexed for the uplink feedback message. In some cases, the quantity of bits may be two bits, and the two bits may be associated with a counter DAI field of the one or more downlink scheduling messages. In other cases, the quantity of bits may be four bits, where two bits of the quantity of bits may be associated with a counter downlink DAI field of the one or more downlink scheduling messages and two bits of the quantity of bits may be associated with a total DAI field of the one or more downlink scheduling messages.

In some cases, the UE 115-b may receive the one or more first downlink scheduling messages via the first cell in accordance with the one or more first time resources, and the UE 115-b may transmit the uplink feedback message via the first cell in accordance with the one or more first time resources. In some examples, the UE 115-b may receive the one or more first downlink scheduling messages in accordance with at least one first time resource of the one or more first time resources, and the UE 115-b may transmit the uplink feedback message via the first cell in accordance with at least one second time resource of the one or more first time resources, where the at least one first time resource is separated from the at least one second time resource by at least one time resource of the one or more second time resources. That is, the UE 115-b may transmit the uplink feedback message in a different case 1 duration than the one or more first downlink scheduling messages.

In some cases, the UE 115-b may receive the one or more second downlink scheduling messages via the second cell in accordance with the one or more second time resources, and the UE 115-b may transmit the uplink feedback message via the first cell in accordance with the one or more first time resources. That is, the UE 115-b may transmit an uplink feedback message for the second cell, which may only support reception at the UE 115-b (e.g., downlink), via time resources associated with the first cell (e.g., during a case 1 duration).

In some implementations, at 525, the UE 115-b and the network entity 105-b may communicate, in accordance with the one or more first downlink scheduling messages, one or more scheduled downlink messages, one or more scheduled uplink messages, or both (e.g., PDSCH, PUSCH, or the like) via the first cell in accordance with the one or more first time resources. Transmission of the uplink feedback message may be in accordance with communicating the one or more scheduled downlink messages, the one or more scheduled uplink messages, or both. In some cases, the UE 115-b may receive the one or more first downlink scheduling messages in accordance with at least one first time resource of the one or more first time resources, and the UE 115-b may communicate the one or more scheduled downlink messages, the one or more scheduled uplink messages, or both via the first cell in accordance with at least one second time resource of the one or more first time resources. The at least one first time resource may be separated from the at least one second time resource by at least one time resource of the one or more second time resources. That is, the UE 115-b may communicate the one or more scheduled downlink messages, the one or more scheduled uplink messages, or both in a different case 1 duration than the one or more first downlink scheduling messages.

In some implementations, at 530, the UE 115-b may receive, in accordance with the one or more second downlink scheduling messages, one or more scheduled downlink messages via the second cell in accordance with the one or more second time resources. Transmission of the uplink feedback message at 520 may be in accordance with the reception of the one or more scheduled downlink messages. In some cases, the UE 115-b may receive the one or more first downlink scheduling messages in accordance with at least one first time resource of the one or more second time resources, and the UE 115-b may receive the one or more scheduled downlink messages via the second cell in accordance with at least one second time resource of the one or more second time resources. The at least one first time resource may be separated from the at least one second time resource by at least one time resource of the one or more first time resources. That is, the UE 115-b may receive the one or more scheduled downlink messages in a different case 2 duration than the one or more first downlink scheduling messages.

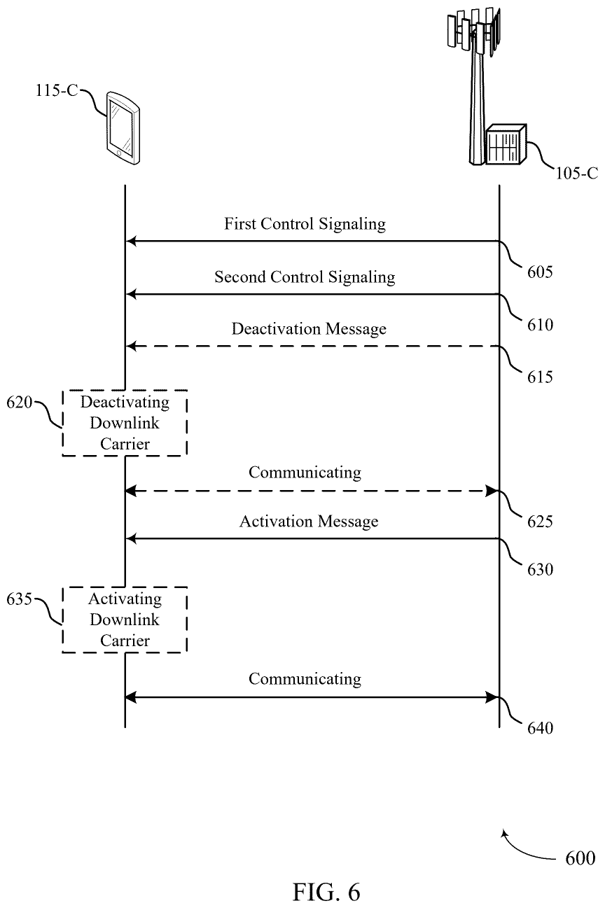

FIG. 6 shows an example of a process flow 600 that supports PHY layer procedures for carrier aggregation switching in accordance with one or more aspects of the present disclosure. The process flow 600 may implement, or be implemented by, aspects of the wireless communications systems 100 and 200, timing diagrams 300 and 400, and process flow 500. For example, the process flow 600 may include one or more network entities 105 and one or more UEs 115, including at least the network entity 105-c and UE 115-c, which may be examples of corresponding devices as described herein, including with reference to FIGS. 1, 2, and 5. The techniques described herein in the context of the process flow 600 may support implementing PHY layer procedures associated with configuration of a single serving cell for using a switching pattern between an FDD cell and an SDL cell based on the activation of an SDL carrier.

At 605, the UE 115-c may receive and the network entity 105-b may transmit, in accordance with a carrier aggregation scheme, first control signaling indicating a first cell associated with transmission and reception at the UE 115-b (e.g., an FDD cell) and indicating a second cell associated with reception at the UE 115-b (e.g., an SDL cell).

At 610, the UE 115-b may receive, and the network entity 105-b may transmit, second control signaling indicating a switching pattern for the first cell and the second cell, where the switching pattern may include one or more first time resources allocated for communication via the first cell (e.g., case 1 durations) and one or more second time resources allocated for communication via the second cell (e.g., case 2 durations). The one or more first time resources may be different from the one or more second time resources.

In some implementations, at 615, the UE 115-c may receive, and the network entity 105-c may transmit, a deactivation message including a deactivation indication. In some cases, the deactivation message may be a MAC-CE message.

In some implementations at 620, the UE 115-c may deactivate the downlink carrier associated with the second cell. In some cases, the UE 115-c may deactivate the downlink carrier associated with the second cell in response to receiving the deactivation message at 615. That is, deactivating the downlink carrier associated with the second cell may be in accordance with receiving the deactivation indication at 615. In other cases, the UE 115-c may deactivate the downlink carrier associated with the second cell in accordance with a threshold period of time passing (e.g., a timer expiring).

In some implementations, at 625, the UE 115-c and the network entity 105-c may communicate, in accordance with the deactivation of the downlink carrier, via the first cell using a third portion of the one or more first time resources and using a fourth portion of the one or more second time resources. That is, the UE 115-c may not implement the switching pattern, or may only operate according to the FDD cell (e.g., case 1) based on deactivating the SDL carrier. In some cases, the UE 115-c and the network entity 105-c may communicate in accordance with the deactivation of the downlink carrier a time gap after deactivation of the downlink carrier.

At 630, the UE 115-c may receive, and the network entity 105-c may transmit, an activation message indicating to activate (e.g., re-activate) a downlink carrier (e.g., SDL carrier) associated with the second cell. In some cases, the activation message may be a MAC-CE message.

In some implementations, at 635, the UE 115-c may activate the downlink carrier associated with the second cell in accordance with receiving the activation message at 630.

At 640, the UE 115-c and the network entity 105-c may communicate, in accordance with the switching pattern and in accordance with receiving the activation message, via the first cell using a first portion of the one or more first time resources and via the second cell using a second portion of the one or more second time resources. That is, based on the SDL carrier being activated, the UE 115-c and the network entity 105-c may communicate according to the switching pattern. In some cases, the UE 115-c and the network entity 105-c may communicate in accordance with the switching pattern a time gap after activation of the downlink carrier associated with the second cell.

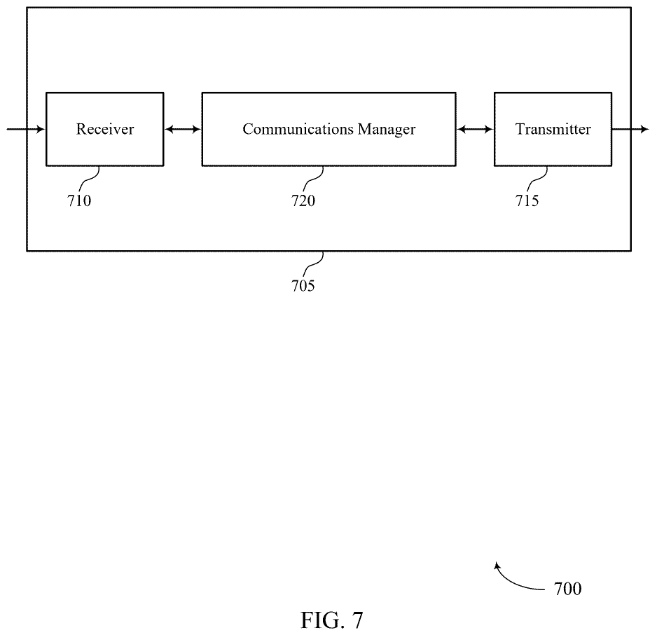

FIG. 7 shows a block diagram 700 of a device 705 that supports PHY layer procedures for carrier aggregation switching in accordance with one or more aspects of the present disclosure. The device 705 may be an example of aspects of a UE 115 as described herein. The device 705 may include a receiver 710, a transmitter 715, and a communications manager 720. The device 705, or one or more components of the device 705 (e.g., the receiver 710, the transmitter 715, the communications manager 720), may include at least one processor, which may be coupled with at least one memory, to, individually or collectively, support or enable the described techniques. Each of these components may be in communication with one another (e.g., via one or more buses).

The receiver 710 may provide a means for receiving information such as packets, user data, control information, or any combination thereof associated with various information channels (e.g., control channels, data channels, information channels related to PHY layer procedures for carrier aggregation switching). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to PHY layer procedures for carrier aggregation switching). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations or components thereof may be examples of means for performing various aspects of PHY layer procedures for carrier aggregation switching as described herein. For example, the communications manager 720, the receiver 710, the transmitter 715, or various combinations or components thereof may be capable of performing one or more of the functions described herein.

In some examples, the communications manager 720, the receiver 710, the transmitter 715, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by one or more processors, individually or collectively, executing instructions stored in the at least one memory).

Additionally, or alternatively, the communications manager 720, the receiver 710, the transmitter 715, or various combinations or components thereof may be implemented in code (e.g., as communications management software or firmware) executed by at least one processor (e.g., referred to as a processor-executable code). If implemented in code executed by at least one processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications in accordance with examples as disclosed herein. For example, the communications manager 720 is capable of, configured to, or operable to support a means for receiving, in accordance with a carrier aggregation scheme, first control signaling indicating a first cell associated with transmission and reception at the UE and indicating a second cell associated with reception at the UE. The communications manager 720 is capable of, configured to, or operable to support a means for receiving second control signaling indicating a switching pattern for the first cell and the second cell, where the switching pattern includes one or more first time resources allocated for communication via the first cell and one or more second time resources allocated for communication via the second cell, and where the one or more first time resources are different from the one or more second time resources. The communications manager 720 is capable of, configured to, or operable to support a means for receiving one or more first downlink scheduling messages via the first cell in accordance with the one or more first time resources, one or more second downlink scheduling messages via the second cell in accordance with the one or more second time resources, or both. The communications manager 720 is capable of, configured to, or operable to support a means for transmitting, in accordance with receiving the one or more first downlink scheduling messages, the one or more second downlink scheduling messages, or both, an uplink feedback message, where a quantity of bits associated with the uplink feedback message is based on the one or more first time resources being different from the one or more second time resources.

Additionally, or alternatively, the communications manager 720 may support wireless communications in accordance with examples as disclosed herein. For example, the communications manager 720 is capable of, configured to, or operable to support a means for receiving, in accordance with a carrier aggregation scheme, first control signaling indicating a first cell associated with transmission and reception at the UE and indicating a second cell associated with reception at the UE. The communications manager 720 is capable of, configured to, or operable to support a means for receiving second control signaling indicating a switching pattern for the first cell and the second cell, where the switching pattern includes one or more first time resources allocated for communication via the first cell and one or more second time resources allocated for communication via the second cell, and where the one or more first time resources are different from the one or more second time resources. The communications manager 720 is capable of, configured to, or operable to support a means for receiving an activation message indicating to activate a downlink carrier associated with the second cell. The communications manager 720 is capable of, configured to, or operable to support a means for communicating, in accordance with the switching pattern and in accordance with receiving the activation message, via the first cell using a first portion of the one or more first time resources and via the second cell using a second portion of the one or more second time resources.

By including or configuring the communications manager 720 in accordance with examples as described herein, the device 705 (e.g., at least one processor controlling or otherwise coupled with the receiver 710, the transmitter 715, the communications manager 720, or a combination thereof) may support techniques for reduced processing, reduced power consumption, and more efficient utilization of communication resources.

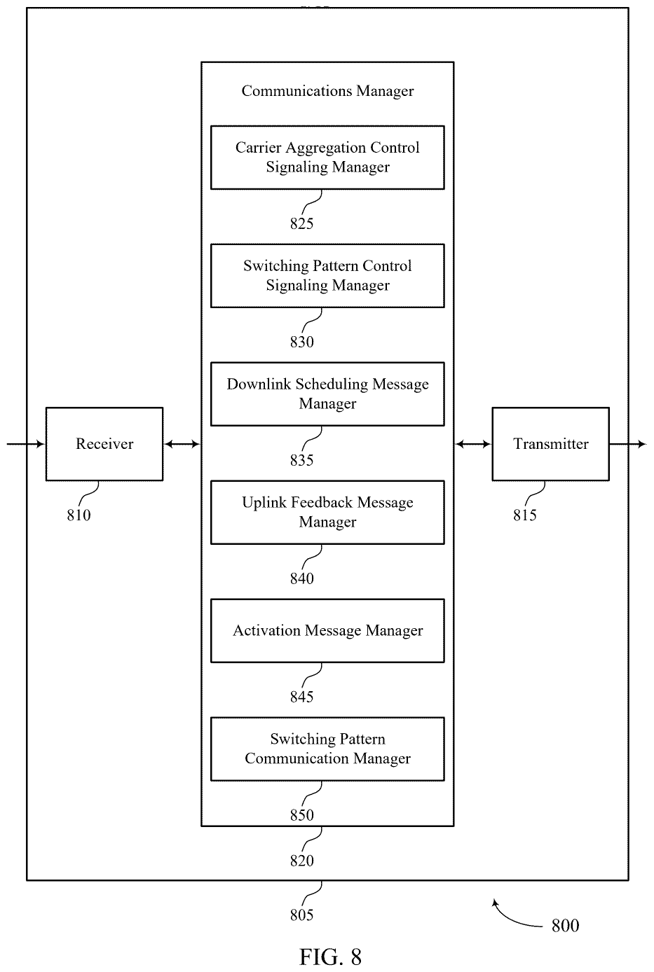

FIG. 8 shows a block diagram 800 of a device 805 that supports PHY layer procedures for carrier aggregation switching in accordance with one or more aspects of the present disclosure. The device 805 may be an example of aspects of a device 705 or a UE 115 as described herein. The device 805 may include a receiver 810, a transmitter 815, and a communications manager 820. The device 805, or one or more components of the device 805 (e.g., the receiver 810, the transmitter 815, the communications manager 820), may include at least one processor, which may be coupled with at least one memory, to support the described techniques. Each of these components may be in communication with one another (e.g., via one or more buses).

The receiver 810 may provide a means for receiving information such as packets, user data, control information, or any combination thereof associated with various information channels (e.g., control channels, data channels, information channels related to PHY layer procedures for carrier aggregation switching). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to PHY layer procedures for carrier aggregation switching). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of PHY layer procedures for carrier aggregation switching as described herein. For example, the communications manager 820 may include a carrier aggregation control signaling manager 825, a switching pattern control signaling manager 830, a downlink scheduling message manager 835, an uplink feedback message manager 840, an activation message manager 845, a switching pattern communication manager 850, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications in accordance with examples as disclosed herein. The carrier aggregation control signaling manager 825 is capable of, configured to, or operable to support a means for receiving, in accordance with a carrier aggregation scheme, first control signaling indicating a first cell associated with transmission and reception at the UE and indicating a second cell associated with reception at the UE. The switching pattern control signaling manager 830 is capable of, configured to, or operable to support a means for receiving second control signaling indicating a switching pattern for the first cell and the second cell, where the switching pattern includes one or more first time resources allocated for communication via the first cell and one or more second time resources allocated for communication via the second cell, and where the one or more first time resources are different from the one or more second time resources. The downlink scheduling message manager 835 is capable of, configured to, or operable to support a means for receiving one or more first downlink scheduling messages via the first cell in accordance with the one or more first time resources, one or more second downlink scheduling messages via the second cell in accordance with the one or more second time resources, or both. The uplink feedback message manager 840 is capable of, configured to, or operable to support a means for transmitting, in accordance with receiving the one or more first downlink scheduling messages, the one or more second downlink scheduling messages, or both, an uplink feedback message, where a quantity of bits associated with the uplink feedback message is based on the one or more first time resources being different from the one or more second time resources.

Additionally, or alternatively, the communications manager 820 may support wireless communications in accordance with examples as disclosed herein. The carrier aggregation control signaling manager 825 is capable of, configured to, or operable to support a means for receiving, in accordance with a carrier aggregation scheme, first control signaling indicating a first cell associated with transmission and reception at the UE and indicating a second cell associated with reception at the UE. The switching pattern control signaling manager 830 is capable of, configured to, or operable to support a means for receiving second control signaling indicating a switching pattern for the first cell and the second cell, where the switching pattern includes one or more first time resources allocated for communication via the first cell and one or more second time resources allocated for communication via the second cell, and where the one or more first time resources are different from the one or more second time resources. The activation message manager 845 is capable of, configured to, or operable to support a means for receiving an activation message indicating to activate a downlink carrier associated with the second cell. The switching pattern communication manager 850 is capable of, configured to, or operable to support a means for communicating, in accordance with the switching pattern and in accordance with receiving the activation message, via the first cell using a first portion of the one or more first time resources and via the second cell using a second portion of the one or more second time resources.

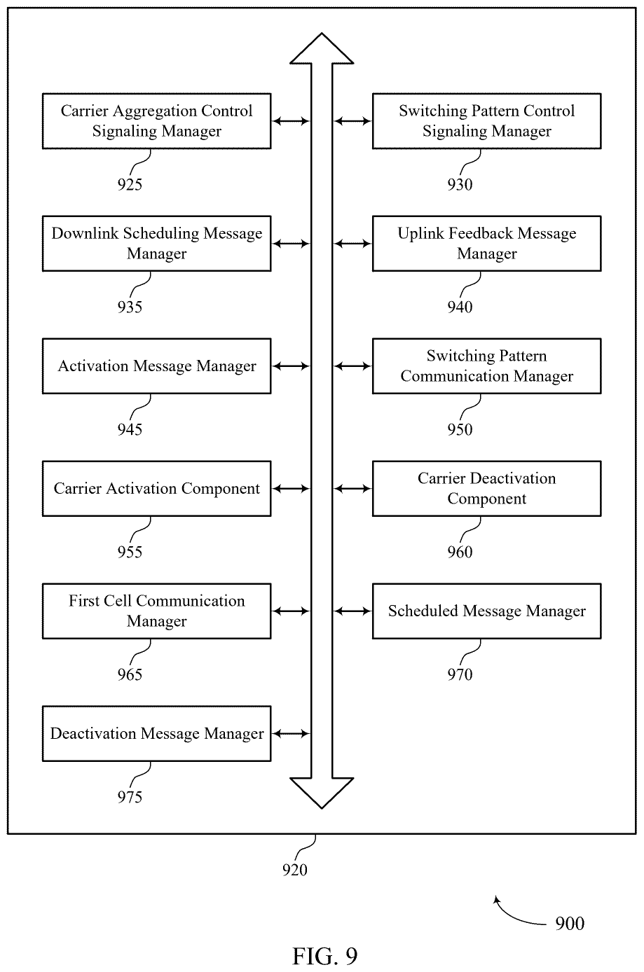

FIG. 9 shows a block diagram 900 of a communications manager 920 that supports PHY layer procedures for carrier aggregation switching in accordance with one or more aspects of the present disclosure. The communications manager 920 may be an example of aspects of a communications manager 720, a communications manager 820, or both, as described herein. The communications manager 920, or various components thereof, may be an example of means for performing various aspects of PHY layer procedures for carrier aggregation switching as described herein. For example, the communications manager 920 may include a carrier aggregation control signaling manager 925, a switching pattern control signaling manager 930, a downlink scheduling message manager 935, an uplink feedback message manager 940, an activation message manager 945, a switching pattern communication manager 950, a carrier activation component 955, a carrier deactivation component 960, a first cell communication manager 965, a scheduled message manager 970, a deactivation message manager 975, or any combination thereof. Each of these components, or components or subcomponents thereof (e.g., one or more processors, one or more memories), may communicate, directly or indirectly, with one another (e.g., via one or more buses).

The communications manager 920 may support wireless communications in accordance with examples as disclosed herein. The carrier aggregation control signaling manager 925 is capable of, configured to, or operable to support a means for receiving, in accordance with a carrier aggregation scheme, first control signaling indicating a first cell associated with transmission and reception at the UE and indicating a second cell associated with reception at the UE. The switching pattern control signaling manager 930 is capable of, configured to, or operable to support a means for receiving second control signaling indicating a switching pattern for the first cell and the second cell, where the switching pattern includes one or more first time resources allocated for communication via the first cell and one or more second time resources allocated for communication via the second cell, and where the one or more first time resources are different from the one or more second time resources. The downlink scheduling message manager 935 is capable of, configured to, or operable to support a means for receiving one or more first downlink scheduling messages via the first cell in accordance with the one or more first time resources, one or more second downlink scheduling messages via the second cell in accordance with the one or more second time resources, or both. The uplink feedback message manager 940 is capable of, configured to, or operable to support a means for transmitting, in accordance with receiving the one or more first downlink scheduling messages, the one or more second downlink scheduling messages, or both, an uplink feedback message, where a quantity of bits associated with the uplink feedback message is based on the one or more first time resources being different from the one or more second time resources.

In some examples, the quantity of bits is two bits, the two bits associated with a counter DAI field of the one or more first downlink scheduling messages, the one or more second downlink scheduling messages, or both.

In some examples, the quantity of bits is four bits. In some examples, two bits of the quantity of bits are associated with a counter DAI field of the one or more first downlink scheduling messages, the one or more second downlink scheduling messages, or both and two bits of the quantity of bits are associated with a total DAI field of the one or more first downlink scheduling messages, the one or more second downlink scheduling messages, or both.

In some examples, the one or more first downlink scheduling messages are received via the first cell in accordance with the one or more first time resources and, to support transmitting the uplink feedback message, the uplink feedback message manager 940 is capable of, configured to, or operable to support a means for transmitting the uplink feedback message via the first cell in accordance with the one or more first time resources.

In some examples, the one or more first downlink scheduling messages are received in accordance with at least one first time resource of the one or more first time resources and, to support transmitting the uplink feedback message, the uplink feedback message manager 940 is capable of, configured to, or operable to support a means for transmitting the uplink feedback message via the first cell in accordance with at least one second time resource of the one or more first time resources, where the at least one first time resource is separated from the at least one second time resource by at least one time resource of the one or more second time resources.

In some examples, the scheduled message manager 970 is capable of, configured to, or operable to support a means for communicating, in accordance with the one or more first downlink scheduling messages, one or more scheduled downlink messages, one or more scheduled uplink messages, or both via the first cell in accordance with the one or more first time resources, where transmission of the uplink feedback message is in accordance with communicating the one or more scheduled downlink messages, the one or more scheduled uplink messages, or both.

In some examples, the one or more first downlink scheduling messages are received in accordance with at least one first time resource of the one or more first time resources and, to support communicating the one or more scheduled downlink messages, the one or more scheduled uplink messages, or both, the scheduled message manager 970 is capable of, configured to, or operable to support a means for communicating the one or more scheduled downlink messages, the one or more scheduled uplink messages, or both via the first cell in accordance with at least one second time resource of the one or more first time resources, where the at least one first time resource is separated from the at least one second time resource by at least one time resource of the one or more second time resources.

In some examples, the one or more second downlink scheduling messages are received via the second cell in accordance with the one or more second time resources and, to support transmitting the uplink feedback message, the uplink feedback message manager 940 is capable of, configured to, or operable to support a means for transmitting the uplink feedback message via the first cell in accordance with the one or more first time resources.

In some examples, the scheduled message manager 970 is capable of, configured to, or operable to support a means for receiving, in accordance with the one or more second downlink scheduling messages, one or more scheduled downlink messages via the second cell in accordance with the one or more second time resources, where transmission of the uplink feedback message is in accordance with the reception of the one or more scheduled downlink messages.

In some examples, the one or more first downlink scheduling messages are received in accordance with at least one first time resource of the one or more second time resources and, to support receiving the one or more scheduled downlink messages, the scheduled message manager 970 is capable of, configured to, or operable to support a means for receiving the one or more scheduled downlink messages via the second cell in accordance with at least one second time resource of the one or more second time resources, where the at least one first time resource is separated from the at least one second time resource by at least one time resource of the one or more first time resources.

Additionally, or alternatively, the communications manager 920 may support wireless communications in accordance with examples as disclosed herein. In some examples, the carrier aggregation control signaling manager 925 is capable of, configured to, or operable to support a means for receiving, in accordance with a carrier aggregation scheme, first control signaling indicating a first cell associated with transmission and reception at the UE and indicating a second cell associated with reception at the UE. In some examples, the switching pattern control signaling manager 930 is capable of, configured to, or operable to support a means for receiving second control signaling indicating a switching pattern for the first cell and the second cell, where the switching pattern includes one or more first time resources allocated for communication via the first cell and one or more second time resources allocated for communication via the second cell, and where the one or more first time resources are different from the one or more second time resources. The activation message manager 945 is capable of, configured to, or operable to support a means for receiving an activation message indicating to activate a downlink carrier associated with the second cell. The switching pattern communication manager 950 is capable of, configured to, or operable to support a means for communicating, in accordance with the switching pattern and in accordance with receiving the activation message, via the first cell using a first portion of the one or more first time resources and via the second cell using a second portion of the one or more second time resources.

In some examples, the carrier activation component 955 is capable of, configured to, or operable to support a means for activating the downlink carrier associated with the second cell in accordance with receiving the activation message.

In some examples, communicating in accordance with the switching pattern occurs a time gap after activation of the downlink carrier associated with the second cell.

In some examples, the carrier deactivation component 960 is capable of, configured to, or operable to support a means for deactivating the downlink carrier associated with the second cell. In some examples, the first cell communication manager 965 is capable of, configured to, or operable to support a means for communicating, in accordance with the deactivation of the downlink carrier, via the first cell using a third portion of the one or more first time resources and using a fourth portion of the one or more second time resources.

In some examples, the deactivation message manager 975 is capable of, configured to, or operable to support a means for receiving a deactivation message including a deactivation indication, where deactivating the downlink carrier associated with the second cell is in accordance with receiving the deactivation indication.

In some examples, the deactivation message is a medium access control-control element (MAC-CE) message.

In some examples, deactivating the downlink carrier associated with the second cell is in accordance with a threshold period of time passing.

In some examples, communicating in accordance with the deactivation of the downlink carrier occurs a time gap after deactivation of the downlink carrier.

In some examples, the activation message is a medium access control-control element (MAC-CE) message.

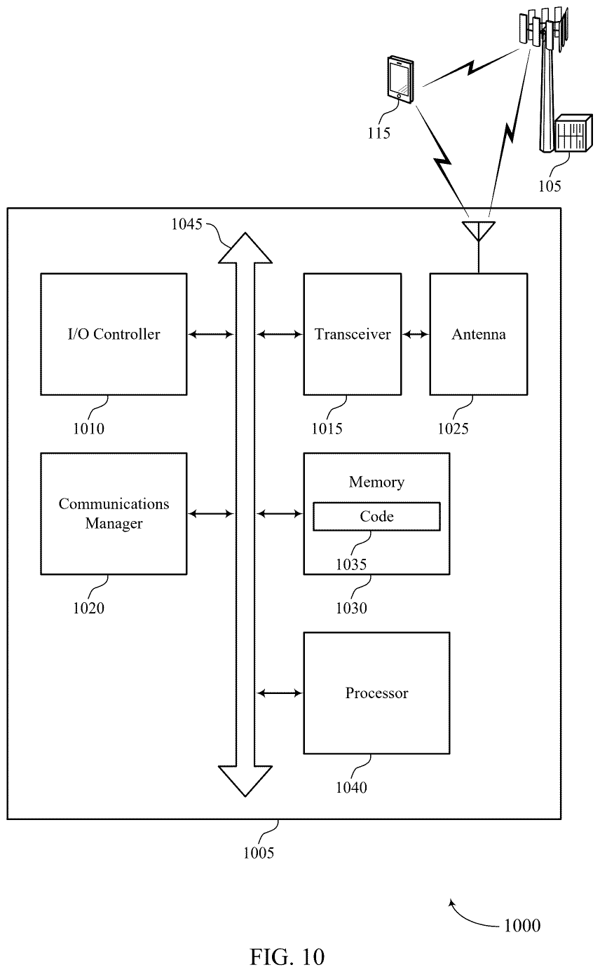

FIG. 10 shows a diagram of a system 1000 including a device 1005 that supports PHY layer procedures for carrier aggregation switching in accordance with one or more aspects of the present disclosure. The device 1005 may be an example of or include components of a device 705, a device 805, or a UE 115 as described herein. The device 1005 may communicate (e.g., wirelessly) with one or more other devices (e.g., network entities 105, UEs 115, or a combination thereof). The device 1005 may include components for bi-directional voice and data communications including components for transmitting and receiving communications, such as a communications manager 1020, an input/output (I/O) controller, such as an I/O controller 1010, a transceiver 1015, one or more antennas 1025, at least one memory 1030, code 1035, and at least one processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally, or alternatively, the I/O controller 1010 may represent or interact with a modem, a keyboard, a mouse, a touchscreen, or a similar device. In some cases, the I/O controller 1010 may be implemented as part of one or more processors, such as the at least one processor 1040. In some cases, a user may interact with the device 1005 via the I/O controller 1010 or via hardware components controlled by the I/O controller 1010.

In some cases, the device 1005 may include a single antenna. However, in some other cases, the device 1005 may have more than one antenna, which may be capable of concurrently transmitting or receiving multiple wireless transmissions. The transceiver 1015 may communicate bi-directionally via the one or more antennas 1025 using wired or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The at least one memory 1030 may include random access memory (RAM) and read-only memory (ROM). The at least one memory 1030 may store computer-readable, computer-executable, or processor-executable code, such as the code 1035. The code 1035 may include instructions that, when executed by the at least one processor 1040, cause the device 1005 to perform various functions described herein. The code 1035 may be stored in a non-transitory computer-readable medium such as system memory or another type of memory. In some cases, the code 1035 may not be directly executable by the at least one processor 1040 but may cause a computer (e.g., when compiled and executed) to perform functions described herein. In some cases, the at least one memory 1030 may include, among other things, a basic I/O system (BIOS) which may control basic hardware or software operation such as the interaction with peripheral components or devices.

The at least one processor 1040 may include one or more intelligent hardware devices (e.g., one or more general-purpose processors, one or more DSPs, one or more CPUs, one or more graphics processing units (GPUs), one or more neural processing units (NPUs) (also referred to as neural network processors or deep learning processors (DLPs)), one or more microcontrollers, one or more ASICs, one or more FPGAs, one or more programmable logic devices, discrete gate or transistor logic, one or more discrete hardware components, or any combination thereof). In some cases, the at least one processor 1040 may be configured to operate a memory array using a memory controller. In some other cases, a memory controller may be integrated into the at least one processor 1040. The at least one processor 1040 may be configured to execute computer-readable instructions stored in a memory (e.g., the at least one memory 1030) to cause the device 1005 to perform various functions (e.g., functions or tasks supporting PHY layer procedures for carrier aggregation switching). For example, the device 1005 or a component of the device 1005 may include at least one processor 1040 and at least one memory 1030 coupled with or to the at least one processor 1040, the at least one processor 1040 and the at least one memory 1030 configured to perform various functions described herein.

In some examples, the at least one processor 1040 may include multiple processors and the at least one memory 1030 may include multiple memories. One or more of the multiple processors may be coupled with one or more of the multiple memories, which may, individually or collectively, be configured to perform various functions described herein. In some examples, the at least one processor 1040 may be a component of a processing system, which may refer to a system (such as a series) of machines, circuitry (including, for example, one or both of processor circuitry (which may include the at least one processor 1040) and memory circuitry (which may include the at least one memory 1030)), or components, that receives or obtains inputs and processes the inputs to produce, generate, or obtain a set of outputs. The processing system may be configured to perform one or more of the functions described herein. For example, the at least one processor 1040 or a processing system including the at least one processor 1040 may be configured to, configurable to, or operable to cause the device 1005 to perform one or more of the functions described herein. Further, as described herein, being “configured to,” being “configurable to,” and being “operable to” may be used interchangeably and may be associated with a capability, when executing code 1035 (e.g., processor-executable code) stored in the at least one memory 1030 or otherwise, to perform one or more of the functions described herein.

The communications manager 1020 may support wireless communications in accordance with examples as disclosed herein. For example, the communications manager 1020 is capable of, configured to, or operable to support a means for receiving, in accordance with a carrier aggregation scheme, first control signaling indicating a first cell associated with transmission and reception at the UE and indicating a second cell associated with reception at the UE. The communications manager 1020 is capable of, configured to, or operable to support a means for receiving second control signaling indicating a switching pattern for the first cell and the second cell, where the switching pattern includes one or more first time resources allocated for communication via the first cell and one or more second time resources allocated for communication via the second cell, and where the one or more first time resources are different from the one or more second time resources. The communications manager 1020 is capable of, configured to, or operable to support a means for receiving one or more first downlink scheduling messages via the first cell in accordance with the one or more first time resources, one or more second downlink scheduling messages via the second cell in accordance with the one or more second time resources, or both. The communications manager 1020 is capable of, configured to, or operable to support a means for transmitting, in accordance with receiving the one or more first downlink scheduling messages, the one or more second downlink scheduling messages, or both, an uplink feedback message, where a quantity of bits associated with the uplink feedback message is based on the one or more first time resources being different from the one or more second time resources.

Additionally, or alternatively, the communications manager 1020 may support wireless communications in accordance with examples as disclosed herein. For example, the communications manager 1020 is capable of, configured to, or operable to support a means for receiving, in accordance with a carrier aggregation scheme, first control signaling indicating a first cell associated with transmission and reception at the UE and indicating a second cell associated with reception at the UE. The communications manager 1020 is capable of, configured to, or operable to support a means for receiving second control signaling indicating a switching pattern for the first cell and the second cell, where the switching pattern includes one or more first time resources allocated for communication via the first cell and one or more second time resources allocated for communication via the second cell, and where the one or more first time resources are different from the one or more second time resources. The communications manager 1020 is capable of, configured to, or operable to support a means for receiving an activation message indicating to activate a downlink carrier associated with the second cell. The communications manager 1020 is capable of, configured to, or operable to support a means for communicating, in accordance with the switching pattern and in accordance with receiving the activation message, via the first cell using a first portion of the one or more first time resources and via the second cell using a second portion of the one or more second time resources.

By including or configuring the communications manager 1020 in accordance with examples as described herein, the device 1005 may support techniques for improved communication reliability, reduced latency, improved user experience related to reduced processing, reduced power consumption, more efficient utilization of communication resources, and improved coordination between devices.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the at least one processor 1040, the at least one memory 1030, the code 1035, or any combination thereof. For example, the code 1035 may include instructions executable by the at least one processor 1040 to cause the device 1005 to perform various aspects of PHY layer procedures for carrier aggregation switching as described herein, or the at least one processor 1040 and the at least one memory 1030 may be otherwise configured to, individually or collectively, perform or support such operations.

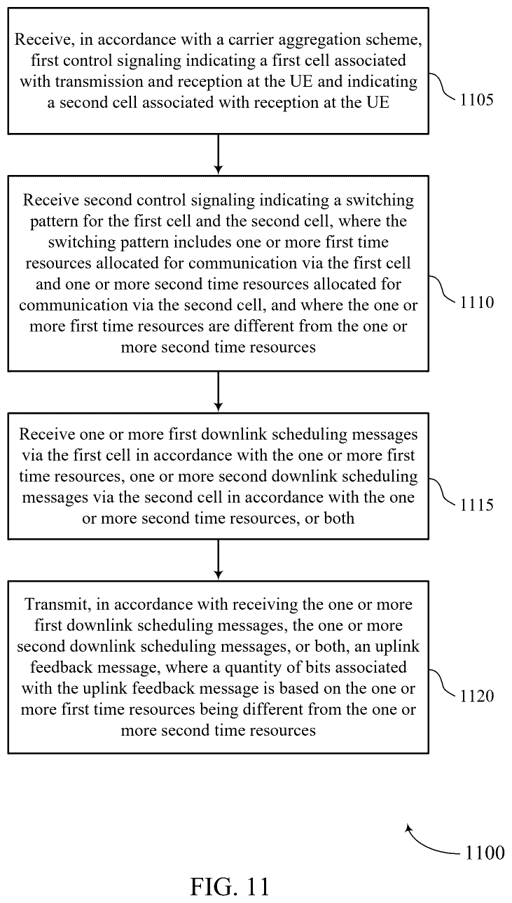

FIG. 11 shows a flowchart illustrating a method 1100 that supports PHY layer procedures for carrier aggregation switching in accordance with one or more aspects of the present disclosure. The operations of the method 1100 may be implemented by a UE or its components as described herein. For example, the operations of the method 1100 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1105, the method may include receiving, in accordance with a carrier aggregation scheme, first control signaling indicating a first cell associated with transmission and reception at the UE and indicating a second cell associated with reception at the UE. The operations of 1105 may be performed in accordance with examples as disclosed herein. In some examples, aspects of the operations of 1105 may be performed by a carrier aggregation control signaling manager 925 as described with reference to FIG. 9.

At 1110, the method may include receiving second control signaling indicating a switching pattern for the first cell and the second cell, where the switching pattern includes one or more first time resources allocated for communication via the first cell and one or more second time resources allocated for communication via the second cell, and where the one or more first time resources are different from the one or more second time resources. The operations of 1110 may be performed in accordance with examples as disclosed herein. In some examples, aspects of the operations of 1110 may be performed by a switching pattern control signaling manager 930 as described with reference to FIG. 9.

At 1115, the method may include receiving one or more first downlink scheduling messages via the first cell in accordance with the one or more first time resources, one or more second downlink scheduling messages via the second cell in accordance with the one or more second time resources, or both. The operations of 1115 may be performed in accordance with examples as disclosed herein. In some examples, aspects of the operations of 1115 may be performed by a downlink scheduling message manager 935 as described with reference to FIG. 9.

At 1120, the method may include transmitting, in accordance with receiving the one or more first downlink scheduling messages, the one or more second downlink scheduling messages, or both, an uplink feedback message, where a quantity of bits associated with the uplink feedback message is based on the one or more first time resources being different from the one or more second time resources. The operations of 1120 may be performed in accordance with examples as disclosed herein. In some examples, aspects of the operations of 1120 may be performed by an uplink feedback message manager 940 as described with reference to FIG. 9.

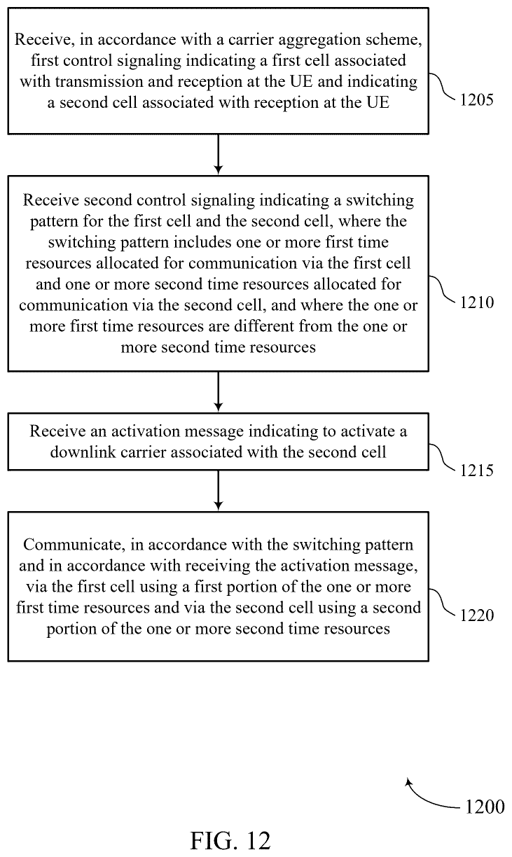

FIG. 12 shows a flowchart illustrating a method 1200 that supports PHY layer procedures for carrier aggregation switching in accordance with one or more aspects of the present disclosure. The operations of the method 1200 may be implemented by a UE or its components as described herein. For example, the operations of the method 1200 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1205, the method may include receiving, in accordance with a carrier aggregation scheme, first control signaling indicating a first cell associated with transmission and reception at the UE and indicating a second cell associated with reception at the UE. The operations of 1205 may be performed in accordance with examples as disclosed herein. In some examples, aspects of the operations of 1205 may be performed by a carrier aggregation control signaling manager 925 as described with reference to FIG. 9.

At 1210, the method may include receiving second control signaling indicating a switching pattern for the first cell and the second cell, where the switching pattern includes one or more first time resources allocated for communication via the first cell and one or more second time resources allocated for communication via the second cell, and where the one or more first time resources are different from the one or more second time resources. The operations of 1210 may be performed in accordance with examples as disclosed herein. In some examples, aspects of the operations of 1210 may be performed by a switching pattern control signaling manager 930 as described with reference to FIG. 9.

At 1215, the method may include receiving an activation message indicating to activate a downlink carrier associated with the second cell. The operations of 1215 may be performed in accordance with examples as disclosed herein. In some examples, aspects of the operations of 1215 may be performed by an activation message manager 945 as described with reference to FIG. 9.

At 1220, the method may include communicating, in accordance with the switching pattern and in accordance with receiving the activation message, via the first cell using a first portion of the one or more first time resources and via the second cell using a second portion of the one or more second time resources. The operations of 1220 may be performed in accordance with examples as disclosed herein. In some examples, aspects of the operations of 1220 may be performed by a switching pattern communication manager 950 as described with reference to FIG. 9.

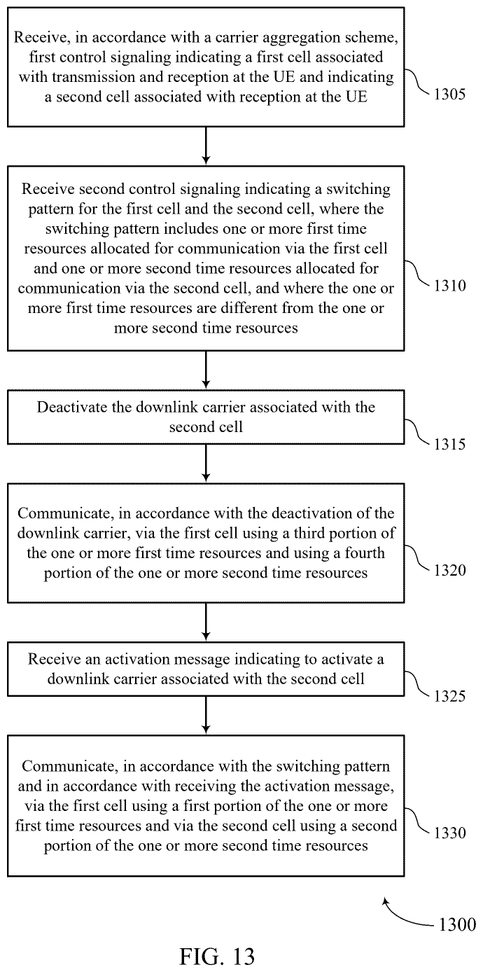

FIG. 13 shows a flowchart illustrating a method 1300 that supports PHY layer procedures for carrier aggregation switching in accordance with one or more aspects of the present disclosure. The operations of the method 1300 may be implemented by a UE or its components as described herein. For example, the operations of the method 1300 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1305, the method may include receiving, in accordance with a carrier aggregation scheme, first control signaling indicating a first cell associated with transmission and reception at the UE and indicating a second cell associated with reception at the UE. The operations of 1305 may be performed in accordance with examples as disclosed herein. In some examples, aspects of the operations of 1305 may be performed by a carrier aggregation control signaling manager 925 as described with reference to FIG. 9.

At 1310, the method may include receiving second control signaling indicating a switching pattern for the first cell and the second cell, where the switching pattern includes one or more first time resources allocated for communication via the first cell and one or more second time resources allocated for communication via the second cell, and where the one or more first time resources are different from the one or more second time resources. The operations of 1310 may be performed in accordance with examples as disclosed herein. In some examples, aspects of the operations of 1310 may be performed by a switching pattern control signaling manager 930 as described with reference to FIG. 9.

At 1315, the method may include deactivating the downlink carrier associated with the second cell. The operations of 1315 may be performed in accordance with examples as disclosed herein. In some examples, aspects of the operations of 1315 may be performed by a carrier deactivation component 960 as described with reference to FIG. 9.

At 1320, the method may include communicating, in accordance with the deactivation of the downlink carrier, via the first cell using a third portion of the one or more first time resources and using a fourth portion of the one or more second time resources. The operations of 1320 may be performed in accordance with examples as disclosed herein. In some examples, aspects of the operations of 1320 may be performed by a first cell communication manager 965 as described with reference to FIG. 9.

At 1325, the method may include receiving an activation message indicating to activate a downlink carrier associated with the second cell. The operations of 1325 may be performed in accordance with examples as disclosed herein. In some examples, aspects of the operations of 1325 may be performed by an activation message manager 945 as described with reference to FIG. 9.

At 1330, the method may include communicating, in accordance with the switching pattern and in accordance with receiving the activation message, via the first cell using a first portion of the one or more first time resources and via the second cell using a second portion of the one or more second time resources. The operations of 1330 may be performed in accordance with examples as disclosed herein. In some examples, aspects of the operations of 1330 may be performed by a switching pattern communication manager 950 as described with reference to FIG. 9.

The following provides an overview of aspects of the present disclosure:
Aspect 1: A method for wireless communications at a UE, comprising: receiving, in accordance with a carrier aggregation scheme, first control signaling indicating a first cell associated with transmission and reception at the UE and indicating a second cell associated with reception at the UE; receiving second control signaling indicating a switching pattern for the first cell and the second cell, wherein the switching pattern comprises one or more first time resources allocated for communication via the first cell and one or more second time resources allocated for communication via the second cell, and wherein the one or more first time resources are different from the one or more second time resources; receiving one or more first downlink scheduling messages via the first cell in accordance with the one or more first time resources, one or more second downlink scheduling messages via the second cell in accordance with the one or more second time resources, or both; and transmitting, in accordance with receiving the one or more first downlink scheduling messages, the one or more second downlink scheduling messages, or both, an uplink feedback message, wherein a quantity of bits associated with the uplink feedback message is based at least in part on the one or more first time resources being different from the one or more second time resources.
Aspect 2: The method of aspect 1, wherein the quantity of bits is two bits, the two bits associated with a counter DAI field of the one or more first downlink scheduling messages, the one or more second downlink scheduling messages, or both.
Aspect 3: The method of any of aspects 1, wherein the quantity of bits is four bits, two bits of the quantity of bits are associated with a counter DAI field of the one or more first downlink scheduling messages, the one or more second downlink scheduling messages, or both and two bits of the quantity of bits are associated with a total DAI field of the one or more first downlink scheduling messages, the one or more second downlink scheduling messages, or both.
Aspect 4: The method of any of aspects 1 through 3, wherein the one or more first downlink scheduling messages are received via the first cell in accordance with the one or more first time resources and wherein transmitting the uplink feedback message comprises: transmitting the uplink feedback message via the first cell in accordance with the one or more first time resources.
Aspect 5: The method of aspect 4, wherein the one or more first downlink scheduling messages are received in accordance with at least one first time resource of the one or more first time resources and wherein transmitting the uplink feedback message comprises: transmitting the uplink feedback message via the first cell in accordance with at least one second time resource of the one or more first time resources, wherein the at least one first time resource is separated from the at least one second time resource by at least one time resource of the one or more second time resources.
Aspect 6: The method of any of aspects 4 through 5, further comprising: communicating, in accordance with the one or more first downlink scheduling messages, one or more scheduled downlink messages, one or more scheduled uplink messages, or both via the first cell in accordance with the one or more first time resources, wherein transmission of the uplink feedback message is in accordance with communicating the one or more scheduled downlink messages, the one or more scheduled uplink messages, or both.
Aspect 7: The method of aspect 6, wherein the one or more first downlink scheduling messages are received in accordance with at least one first time resource of the one or more first time resources and wherein communicating the one or more scheduled downlink messages, the one or more scheduled uplink messages, or both comprises: communicating the one or more scheduled downlink messages, the one or more scheduled uplink messages, or both via the first cell in accordance with at least one second time resource of the one or more first time resources, wherein the at least one first time resource is separated from the at least one second time resource by at least one time resource of the one or more second time resources.
Aspect 8: The method of any of aspects 1 through 7, wherein the one or more second downlink scheduling messages are received via the second cell in accordance with the one or more second time resources, and wherein transmitting the uplink feedback message comprises: transmitting the uplink feedback message via the first cell in accordance with the one or more first time resources.
Aspect 9: The method of aspect 8, further comprising: receiving, in accordance with the one or more second downlink scheduling messages, one or more scheduled downlink messages via the second cell in accordance with the one or more second time resources, wherein transmission of the uplink feedback message is in accordance with the reception of the one or more scheduled downlink messages.
Aspect 10: The method of aspect 9,wherein the one or more first downlink scheduling messages are received in accordance with at least one first time resource of the one or more second time resources and wherein receiving the one or more scheduled downlink messages comprises: receiving the one or more scheduled downlink messages via the second cell in accordance with at least one second time resource of the one or more second time resources, wherein the at least one first time resource is separated from the at least one second time resource by at least one time resource of the one or more first time resources.
Aspect 11: A method for wireless communications at a UE, comprising: receiving, in accordance with a carrier aggregation scheme, first control signaling indicating a first cell associated with transmission and reception at the UE and indicating a second cell associated with reception at the UE; receiving second control signaling indicating a switching pattern for the first cell and the second cell, wherein the switching pattern comprises one or more first time resources allocated for communication via the first cell and one or more second time resources allocated for communication via the second cell, and wherein the one or more first time resources are different from the one or more second time resources; receiving an activation message indicating to activate a downlink carrier associated with the second cell; and communicating, in accordance with the switching pattern and in accordance with receiving the activation message, via the first cell using a first portion of the one or more first time resources and via the second cell using a second portion of the one or more second time resources.
Aspect 12: The method of aspect 11, further comprising: activating the downlink carrier associated with the second cell in accordance with receiving the activation message.
Aspect 13: The method of aspect 12, wherein communicating in accordance with the switching pattern occurs a time gap after activation of the downlink carrier associated with the second cell.
Aspect 14: The method of any of aspects 11 through 13, further comprising: deactivating the downlink carrier associated with the second cell; and communicating, in accordance with the deactivation of the downlink carrier, via the first cell using a third portion of the one or more first time resources and using a fourth portion of the one or more second time resources.
Aspect 15: The method of aspect 14, further comprising: receiving a deactivation message comprising a deactivation indication, wherein deactivating the downlink carrier associated with the second cell is in accordance with receiving the deactivation indication.
Aspect 16: The method of aspect 15, wherein the deactivation message is a MAC-CE message.
Aspect 17: The method of any of aspects 14 through 16, wherein deactivating the downlink carrier associated with the second cell is in accordance with a threshold period of time passing.
Aspect 18: The method of any of aspects 14 through 17, wherein communicating in accordance with the deactivation of the downlink carrier occurs a time gap after deactivation of the downlink carrier.
Aspect 19: The method of any of aspects 11 through 18, wherein the activation message is a MAC-CE message.
Aspect 20: A UE for wireless communications, comprising one or more memories storing processor-executable code, and one or more processors coupled with the one or more memories and individually or collectively operable to execute the code to cause the UE to perform a method of any of aspects 1 through 10.
Aspect 21: A UE for wireless communications, comprising at least one means for performing a method of any of aspects 1 through 10.
Aspect 22: A non-transitory computer-readable medium storing code for wireless communications, the code comprising instructions executable by one or more processors to perform a method of any of aspects 1 through 10.
Aspect 23: A UE for wireless communications, comprising one or more memories storing processor-executable code, and one or more processors coupled with the one or more memories and individually or collectively operable to execute the code to cause the UE to perform a method of any of aspects 11 through 19.
Aspect 24: A UE for wireless communications, comprising at least one means for performing a method of any of aspects 11 through 19.
Aspect 25: A non-transitory computer-readable medium storing code for wireless communications, the code comprising instructions executable by one or more processors to perform a method of any of aspects 11 through 19.

It should be noted that the methods described herein describe possible implementations. The operations and the steps may be rearranged or otherwise modified and other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, a graphics processing unit (GPU), a neural processing unit (NPU), an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk, and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” and “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database, or another data structure), ascertaining, and the like. Also, “determining” can include receiving (e.g., receiving information), accessing (e.g., accessing data stored in memory), and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label or other subsequent reference label.

The description set forth herein, in connection with the appended drawings, describes example configurations and does not represent all the examples that may be implemented or that are within the scope of the claims. The term “example” used herein means “serving as an example, instance, or illustration” and not “preferred” or “advantageous over other examples.” The detailed description includes specific details for the purpose of providing an understanding of the described techniques. These techniques, however, may be practiced without these specific details. In some figures, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE), comprising:
one or more memories storing processor-executable code; and
one or more processors coupled with the one or more memories and individually or collectively operable to execute the code to cause the UE to:
receive, in accordance with a carrier aggregation scheme, first control signaling indicating a first cell associated with transmission and reception at the UE and indicating a second cell associated with reception at the UE;
receive second control signaling indicating a switching pattern for the first cell and the second cell, wherein the switching pattern comprises one or more first time resources allocated for communication via the first cell and one or more second time resources allocated for communication via the second cell, and wherein the one or more first time resources are different from the one or more second time resources;
receive one or more first downlink scheduling messages via the first cell in accordance with the one or more first time resources, one or more second downlink scheduling messages via the second cell in accordance with the one or more second time resources, or both; and
transmit, in accordance with receiving the one or more first downlink scheduling messages, the one or more second downlink scheduling messages, or both, an uplink feedback message, wherein a quantity of bits associated with the uplink feedback message is based at least in part on the one or more first time resources being different from the one or more second time resources.

2. The UE of claim 1, wherein the quantity of bits is two bits, the two bits associated with a counter downlink assignment index field of the one or more first downlink scheduling messages, the one or more second downlink scheduling messages, or both.

3. The UE of claim 1, wherein:
the quantity of bits is four bits, and
two bits of the quantity of bits are associated with a counter downlink assignment index field of the one or more first downlink scheduling messages, the one or more second downlink scheduling messages, or both and two bits of the quantity of bits are associated with a total downlink assignment index field of the one or more first downlink scheduling messages, the one or more second downlink scheduling messages, or both.

4. The UE of claim 1, wherein the one or more first downlink scheduling messages are received via the first cell in accordance with the one or more first time resources and wherein, to transmit the uplink feedback message, the one or more processors are individually or collectively operable to execute the code to cause the UE to:
transmit the uplink feedback message via the first cell in accordance with the one or more first time resources.

5. The UE of claim 4, wherein the one or more first downlink scheduling messages are received in accordance with at least one first time resource of the one or more first time resources and wherein, to transmit the uplink feedback message, the one or more processors are individually or collectively operable to execute the code to cause the UE to:
transmit the uplink feedback message via the first cell in accordance with at least one second time resource of the one or more first time resources, wherein the at least one first time resource is separated from the at least one second time resource by at least one time resource of the one or more second time resources.

6. The UE of claim 4, wherein the one or more processors are individually or collectively further operable to execute the code to cause the UE to:
communicate, in accordance with the one or more first downlink scheduling messages, one or more scheduled downlink messages, one or more scheduled uplink messages, or both via the first cell in accordance with the one or more first time resources, wherein transmission of the uplink feedback message is in accordance with communicating the one or more scheduled downlink messages, the one or more scheduled uplink messages, or both.

7. The UE of claim 6, wherein the one or more first downlink scheduling messages are received in accordance with at least one first time resource of the one or more first time resources and wherein, to communicate the one or more scheduled downlink messages, the one or more scheduled uplink messages, or both, the one or more processors are individually or collectively operable to execute the code to cause the UE to:
communicate the one or more scheduled downlink messages, the one or more scheduled uplink messages, or both via the first cell in accordance with at least one second time resource of the one or more first time resources, wherein the at least one first time resource is separated from the at least one second time resource by at least one time resource of the one or more second time resources.

8. The UE of claim 1, wherein the one or more second downlink scheduling messages are received via the second cell in accordance with the one or more second time resources, and, to transmit the uplink feedback message, the one or more processors are individually or collectively operable to execute the code to cause the UE to:
transmit the uplink feedback message via the first cell in accordance with the one or more first time resources.

9. The UE of claim 8, wherein the one or more processors are individually or collectively further operable to execute the code to cause the UE to:
receive, in accordance with the one or more second downlink scheduling messages, one or more scheduled downlink messages via the second cell in accordance with the one or more second time resources, wherein transmission of the uplink feedback message is in accordance with the reception of the one or more scheduled downlink messages.

10. The UE of claim 9, wherein the one or more first downlink scheduling messages are received in accordance with at least one first time resource of the one or more second time resources and wherein, to receive the one or more scheduled downlink messages, the one or more processors are individually or collectively operable to execute the code to cause the UE to:
receive the one or more scheduled downlink messages via the second cell in accordance with at least one second time resource of the one or more second time resources, wherein the at least one first time resource is separated from the at least one second time resource by at least one time resource of the one or more first time resources.

11. A user equipment (UE), comprising:
one or more memories storing processor-executable code; and
one or more processors coupled with the one or more memories and individually or collectively operable to execute the code to cause the UE to:
receive, in accordance with a carrier aggregation scheme, first control signaling indicating a first cell associated with transmission and reception at the UE and indicating a second cell associated with reception at the UE;
receive second control signaling indicating a switching pattern for the first cell and the second cell, wherein the switching pattern comprises one or more first time resources allocated for communication via the first cell and one or more second time resources allocated for communication via the second cell, and wherein the one or more first time resources are different from the one or more second time resources;
receive an activation message indicating to activate a downlink carrier associated with the second cell; and
communicate, in accordance with the switching pattern and in accordance with receiving the activation message, via the first cell using a first portion of the one or more first time resources and via the second cell using a second portion of the one or more second time resources.

12. The UE of claim 11, wherein the one or more processors are individually or collectively further operable to execute the code to cause the UE to:
activate the downlink carrier associated with the second cell in accordance with receiving the activation message.

13. The UE of claim 12, wherein communicating in accordance with the switching pattern occurs a time gap after activation of the downlink carrier associated with the second cell.

14. The UE of claim 11, wherein the one or more processors are individually or collectively further operable to execute the code to cause the UE to:
deactivate the downlink carrier associated with the second cell; and
communicate, in accordance with the deactivation of the downlink carrier, via the first cell using a third portion of the one or more first time resources and using a fourth portion of the one or more second time resources.

15. The UE of claim 14, wherein the one or more processors are individually or collectively further operable to execute the code to cause the UE to:
receive a deactivation message comprising a deactivation indication, wherein deactivating the downlink carrier associated with the second cell is in accordance with receiving the deactivation indication.

16. The UE of claim 15, wherein the deactivation message is a medium access control-control element (MAC-CE) message.

17. The UE of claim 14, wherein deactivating the downlink carrier associated with the second cell is in accordance with a threshold period of time passing.

18. The UE of claim 14, wherein communicating in accordance with the deactivation of the downlink carrier occurs a time gap after deactivation of the downlink carrier.

19. The UE of claim 11, wherein the activation message is a medium access control-control element (MAC-CE) message.

20. A method for wireless communications at a user equipment (UE), comprising:
receiving, in accordance with a carrier aggregation scheme, first control signaling indicating a first cell associated with transmission and reception at the UE and indicating a second cell associated with reception at the UE;
receiving second control signaling indicating a switching pattern for the first cell and the second cell, wherein the switching pattern comprises one or more first time resources allocated for communication via the first cell and one or more second time resources allocated for communication via the second cell, and wherein the one or more first time resources are different from the one or more second time resources;
receiving one or more first downlink scheduling messages via the first cell in accordance with the one or more first time resources, one or more second downlink scheduling messages via the second cell in accordance with the one or more second time resources, or both; and
transmitting, in accordance with receiving the one or more first downlink scheduling messages, the one or more second downlink scheduling messages, or both, an uplink feedback message, wherein a quantity of bits associated with the uplink feedback message is based at least in part on the one or more first time resources being different from the one or more second time resources.
